(19) United States
(12) Patent Application Publication
(10) Pub. No.: US 2026/0235800 A1
(43) Pub. Date: Aug. 13, 2026

(54) Overlapped Fiber Bragg Gratings With Different Reflectivities

(71) Applicant: INTUITIVE SURGICAL OPERATIONS, INC., Sunnyvale, CA (US)

(72) Inventors: Brooks A. Childers, Christiansburg, VA (US); Patrick Roye, Christiansburg, VA (US); Kevin M. Marsden, Blacksburg, VA (US)

(21) Appl. No.: 19/532,241

(22) Filed: Feb. 6, 2026

Related U.S. Application Data
(60) Provisional application No. 63/755,576, filed on Feb. 7, 2025.

(51) Int. Cl. G02B 6/02; G01D 5/353

(52) U.S. Cl. CPC G02B 6/02138; G01D 5/35316; G02B 6/02085

(57) ABSTRACT

Techniques for writing overlapped fiber Bragg gratings with different reflectivities are disclosed herein. An example grating writing system for optical fibers includes a laser source emitting ultraviolet light, a positioning system adjusting pose parameters of the optical fiber, laser source, or associated optical components, and a control system with processors. The control system directs the laser source and positioning system so that a first ultraviolet pulse alters reflectivity of a first fiber portion by a first amplitude, and a second pulse alters a second portion by a second amplitude. The first and second portions partially overlap, with a nonzero ratio between the first and second amplitudes in the overlap region. The present techniques improve manufacturing yield and sensor performance by controlling amplitude ratios between adjacent overlapping gratings to maintain overlap region reflectivity within acceptable bounds.

### CROSS-REFERENCE TO RELATED APPLICATIONS

This application claims priority to U.S. Provisional Application No. 63/755,576, entitled “Overlapped Fiber Bragg Gratings with Different Reflectivities”, filed on Feb. 7, 2025, which is hereby incorporated by reference in its entirety

### FIELD

Disclosed examples relate to grating writing techniques, and more particularly to systems and methods for writing overlapping fiber Bragg gratings with different reflectivities.

### BACKGROUND

Fiber Bragg grating arrays written in optical fibers can experience regions of reduced or absent reflectivity due to gaps between adjacent gratings or phase relationships between overlapping gratings resulting in signal cancellation. Manufacturing such grating arrays can be challenging, particularly in achieving the precision placement of gratings that would avoid these regions of unacceptably low reflectivity, which can negatively affect manufacturing yield and sensor performance.

### SUMMARY

The following presents a simplified summary of various examples described herein and is not intended to identify key or critical elements or to delineate the scope of the claims.

In some aspects, the techniques described herein relate to an optical fiber sensor. The optical fiber sensor includes an optical core. The optical fiber sensor includes a first grating in the optical core having a first spatial reflectivity profile. The optical fiber sensor includes a second grating in the optical core having a second spatial reflectivity profile. The first grating and the second grating overlap in an overlap region. A first value of the first spatial reflectivity profile in the overlap region differs from a second value of the second spatial reflectivity profile in the overlap region, and the first and second values are nonzero.

In some aspects, the techniques described herein relate to a grating writing system for writing gratings in an optical fiber. The grating writing system includes a laser source configured to emit ultraviolet light. The grating writing system includes a positioning system configured to adjust at least one pose parameter selected from the group consisting of: a position of the optical fiber, an orientation of the optical fiber, a position of a part of the laser source, an orientation of the part of the laser source, a position of an optical component associated with the laser source, or an orientation of the optical component. The grating writing system includes a control system comprising one or more processors, the one or more processors comprising circuitry. The control system is configured to control the laser source and to cause the positioning system to adjust the at least one pose parameter such that (i) a first ultraviolet light pulse emitted by the laser source is directed to interact with a first portion of the optical fiber to alter a reflectivity of the first portion by a first amplitude and (ii) a second ultraviolet light pulse emitted by the laser source is directed to interact with a second portion of the optical fiber to alter a reflectivity of the second portion by a second amplitude. The first portion partially overlaps with the second portion in an overlap region, and a ratio of the first amplitude in the overlap region and the second amplitude in the overlap region is nonzero.

In some aspects, the techniques described herein relate to an optical fiber sensor. The optical fiber sensor includes a strand of glass or plastic. The optical fiber sensor includes a first grating disposed in a first portion of the strand, the first grating altering a reflectivity of the first portion by a first amplitude compared to a reflectivity of the strand without any gratings. The optical fiber sensor includes a second grating disposed in a second portion of the strand, the second grating altering a reflectivity of the second portion by a second amplitude compared to a reflectivity of the strand without any gratings. The first portion and the second portion partially overlap in an overlap region, and a ratio of the first amplitude and the second amplitude in the overlap region is nonzero.

In some aspects, the techniques described herein relate to a method for writing overlapping gratings in an optical fiber. The method includes causing, by a control system comprising one or more processors, an adjustment to at least one pose parameter selected from the group consisting of: a position of the optical fiber, an orientation of the optical fiber, a position of a part of a laser source configured to emit ultraviolet light, an orientation of the part of the laser source, a position of an optical component associated with the laser source, or an orientation of the optical component. The method includes causing, by the control system, the laser source to emit (i) a first ultraviolet light pulse that is directed to interact with a first portion of the optical fiber to alter a reflectivity of the first portion by a first amplitude and (ii) a second ultraviolet light pulse directed to interact with a second portion of the optical fiber to alter a reflectivity of the second portion by a second amplitude. The first portion partially overlaps with the second portion in an overlap region, and a ratio of the first amplitude in the overlap region and the second amplitude in the overlap region is nonzero.

It is to be understood that both the foregoing general description and the following detailed description are illustrative and explanatory in nature and are intended to provide an understanding of the present disclosure without limiting the scope of the present disclosure. In that regard, additional aspects, features, and advantages of the present disclosure will be apparent to one skilled in the art from the following detailed description.

### BRIEF DESCRIPTIONS OF THE DRAWINGS

FIG. 1A depicts an example grating writing system for writing gratings in an optical fiber, in accordance with various aspects of the present disclosure.

FIG. 1B depicts an example grating writing system for writing gratings in an optical fiber, in accordance with various aspects of the present disclosure.

FIG. 1C depicts a longitudinal view of an optical fiber showing overlapping fiber Bragg gratings with different reflectivities, in accordance with various aspects of the present disclosure.

FIG. 1D depicts a single-core fiber cross-section showing a cross-sectional view of an optical fiber containing a single core, in accordance with various aspects of the present disclosure.

FIG. 1E depicts a multi-core fiber cross-section showing a cross-sectional view of an optical fiber containing multiple cores, in accordance with various aspects of the present disclosure.

FIG. 1F depicts a cross-sectional view of a bundle of single-core fibers fixed to each other, in accordance with various aspects of the present disclosure.

FIG. 1G depicts a cross-sectional view of a hybrid fiber configuration combining single-core fibers with multi-core fibers, in accordance with various aspects of the present disclosure.

FIG. 2 depicts an interrogator ranging system configured to provide free space laser ranging capability, in accordance with various aspects of the present disclosure.

FIG. 3A depicts a first example optical component configuration for inscribing gratings in an optical fiber, in accordance with various aspects of the present disclosure.

FIG. 3B depicts a second example optical component configuration for inscribing gratings in an optical fiber, in accordance with various aspects of the present disclosure.

FIG. 3C depicts a third example optical component configuration with a tunable interferometer, in accordance with various aspects of the present disclosure.

FIG. 3D depicts a fourth example optical component configuration with a cylindrical lens, in accordance with various aspects of the present disclosure.

FIG. 3E depicts a fifth example optical component configuration with a rectangular prism, in accordance with various aspects of the present disclosure.

FIG. 3F depicts a sixth example optical component configuration with two phase masks, in accordance with various aspects of the present disclosure.

FIG. 4 depicts an example grating writing process, in accordance with various aspects of the present disclosure.

FIG. 5A depicts example refractive index modulation plots showing refractive index modulation along an optical fiber for single gratings with different normalized index of refraction amplitudes, in accordance with various aspects of the present disclosure.

FIG. 5B depicts example effective refractive index modulation plots showing the summation of two sinusoids with phase differences, in accordance with various aspects of the present disclosure.

FIG. 6A depicts example fiber sensor simulations showing reflectivity profiles for simulated fiber sensor arrays with different grating reflectivity ratios, in accordance with various aspects of the present disclosure.

FIG. 6B depicts an example reflectivities plot showing average and minimum reflectivity as a function of ratio for simulated fiber sensor arrays, in accordance with various aspects of the present disclosure.

FIG. 6C depicts an example ratio plot providing a graphical representation of grating reflectivity conditions, in accordance with various aspects of the present disclosure.

FIG. 7A depicts an example two grating reflectivity plot showing an example Gaussian-like profile, in accordance with various aspects of the present disclosure.

FIG. 7B depicts an example reflectivity ratio plot showing idealized gratings having Gaussian-like shaped reflectivities arranged in an array, in accordance with various aspects of the present disclosure.

FIG. 8 depicts example apertured reflectivity plots showing how apertured laser beams can be used to write shorter gratings, in accordance with various aspects of the present disclosure.

FIG. 9A depicts a first example apertured ratio plot showing alternating gratings along a fiber sensor with a first spacing configuration, in accordance with various aspects of the present disclosure.

FIG. 9B depicts a second example apertured ratio plot with a second spacing configuration, in accordance with various aspects of the present disclosure.

FIG. 9C depicts a third example apertured ratio plot with a third spacing configuration, in accordance with various aspects of the present disclosure.

FIG. 10A depicts a first example ramped reflectivity plot showing gratings with ramped reflectivity shapes at a first overlap spacing, in accordance with various aspects of the present disclosure.

FIG. 10B depicts a second example ramped reflectivity plot showing gratings with ramped reflectivity shapes at a second overlap spacing, in accordance with various aspects of the present disclosure.

FIG. 10C depicts a third example ramped reflectivity plot showing gratings with ramped reflectivity shapes at a third overlap spacing, in accordance with various aspects of the present disclosure.

FIG. 11 depicts an example offset aperture reflectivity plot showing a ratio plot for gratings created by an offset aperture, in accordance with various aspects of the present disclosure.

FIG. 12 depicts an example method for writing overlapping gratings in an optical fiber, in accordance with various aspects of the present disclosure.

Examples of the present disclosure and their advantages are best understood by referring to the detailed description that follows. It should be appreciated that like reference numerals are used to identify like elements illustrated in one or more of the figures, wherein showings therein are for purposes of illustrating examples of the present disclosure and not for purposes of limiting the same.

### DETAILED DESCRIPTION

In the following description, specific details are set forth describing some examples consistent with the present disclosure. Numerous specific details are set forth in order to provide a thorough understanding of the examples. It will be apparent, however, to one skilled in the art that some examples may be practiced without some or all of these specific details. The specific examples disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one example may be incorporated into other examples unless specifically described otherwise or if the one or more features would make an example non-functional. In some instances, well known methods, procedures, components, and circuits have not been described in detail so as not to unnecessarily obscure aspects of the examples.

The present disclosure describes various systems, devices, and methods for writing overlapping fiber Bragg gratings with different reflectivities. The present techniques control the ratio of reflectivity amplitudes between adjacent overlapping gratings to reduce the likelihood of regions within optical fibers having unacceptably low reflectivity. The present disclosure encompasses grating writing systems configured to produce gratings with controlled reflectivity ratios, optical fiber sensors incorporating such gratings, and methods for writing overlapping gratings in optical fibers.

Gratings can be “written” in a waveguide (such as an optical core of an optical fiber) by selectively applying ultraviolet (UV) light, such as that generated by a UV laser. Exposure to the UV light causes changes in the local index of refraction in the waveguide. Spacing the changes in index of refraction appropriately can provide a fiber Bragg grating (FBG). The FBG is a type of distributed Bragg reflector that reflects particular wavelength(s) of light and transmits all others. A single frequency FBG can be created with a periodic variation in the refractive index of the fiber core, which generates a wavelength-specific reflection effect. In an example, the refractive index alternates periodically over a defined length of the optical waveguide (e.g., a core in an optical fiber). An example grating writing technique is described in U.S. Pat. No. 10,698,153, filed Jan. 18, 2019, which is incorporated herein by reference in its entirety.

The reflected wavelength for a fiber Bragg grating (λ_B), often called the Bragg wavelength, can be calculated using the relationship λ_{B}=2nₑΛ, where nₑ is the effective refractive index of the fiber core and Λ is the grating period. Fiber Bragg gratings can be used in many different applications, such as an inline optical filter that filters out certain wavelength(s) of light (reflects the wavelength(s) instead of allowing transmission); used in sensing strain, temperature, shape, etc.; used as a wavelength-specific reflector, etc. Examples for determining twist and/or bend angle with a fiber sensor is further discussed in U.S. Pat. No. 11,473,902, filed Jan. 6, 2021. A fiber sensor used for shape sensing can comprise a fiber containing multiple cores, a bundle of single core fibers, or a combination thereof. The fiber sensor may comprise a central core, and a plurality (e.g., 2, 3, 4, 5, 6, or higher) helically or otherwise spun about the central core along the length of the fiber sensor.

Broader-band, multi-frequency FBGs can be provided by changing the period of the grating along the length of the grating. In some applications, it is desirable to produce a continuous array of Bragg gratings, with the gratings spaced such that the distance between gratings is the same as the grating period, or within a tolerance of the grating period. Such arrays of Bragg gratings can appear and function like a single, long grating. However, in some manufacturing processes, the gratings are produced in a way that gaps can result between the gratings.

For fiber Bragg gratings written into optical cores of optical fibers, the gratings can be written after the fiber has been manufactured using an appropriate fixtures and equipment. Gratings can also be written during the fiber draw process. For example, a technique for manufacturing arrays of continuous Bragg gratings in one or more cores of an optical fiber involves writing each grating with a single laser pulse, while the fiber is continuously moved. In this example, to write a continuous array of gratings, the processing system of the manufacturing equipment controls the laser firing and fiber movement such that each grating is written in a precise sequential location relative to the other gratings, to try to achieve no gap between adjacent gratings, and also no overlap between adjacent gratings. Gaps can lead to regions with no effective sensor signal. Overlaps can lead to regions with noisy or inaccurate signals. Depending on the intended use and application, the acceptable overlap or gap can be non-zero, and depend on the requirements of such intended use and application.

In various applications, it is desirable to reduce or eliminate the number and/or size of gaps, or to eliminate gaps completely. In general, and disregarding Rayleigh scatter and reflection due to naturally occurring changes in index of refraction due to imperfections in the light guide, the reflectivity in a gap region is effectively zero. Where the gap is in an optical core for sensing, the gap being a region in which the core does provide reflective signal can lead to a region where the sensor cannot sense accurately, or perhaps sense at all. As referenced herein, “reflectivity” may generally be a measure of the modulation in the index of refraction, e.g., resulting from a grating or multiple gratings written in a waveguide, as the reflectivity has a known, non-linear relationship with the modulation in the index of refraction.

As referenced herein, a “spatial reflectivity profile” of a grating may generally indicate how the reflectivity of the grating varies as a function of position along the length of the grating. The “values” of a spatial reflectivity profile may refer to the reflectivity amplitude at particular positions along the grating. For gratings written with uniform beam profiles, the spatial reflectivity profile may be substantially constant across the grating length, such that the values of the profile are approximately equal at different positions within the grating. For gratings written with non-uniform beam profiles (e.g., Gaussian-like profiles or ramped profiles), the spatial reflectivity profile may vary along the grating length, generally following the spatial energy distribution of the writing beam. When comparing first and second values of spatial reflectivity profiles in an overlap region, these values may refer to the respective reflectivity contributions from each grating at corresponding positions within that overlap region. In some aspects, two gratings may have similar spatial reflectivity profile shapes yet still have different values in the overlap region due to differences in peak amplitude, relative positioning of the gratings, or the spatial energy profile of the writing beam used to create each grating.

In contrast, in regions where two gratings of the same nominal reflectivity overlap in a core of an optical fiber, the reflectivity of the core may be approximately between zero and twice the nominal reflectivity. A resulting reflectivity of zero due to an out of phase overlap of gratings can produce a region of the core where no sensor signal can be obtained through reflection, and can be undesirable in many instances. The effects of overlapping gratings are discussed further below.

The techniques described herein can be used to write Type 1 gratings, as well as other types of gratings. For Type 1 gratings in a core of an optical fiber, the UV light induced index change is approximately proportional to the laser fluence. Type 1 gratings are generally written with moderate intensities below a certain threshold and exhibit an index grating across the core. Type 1 gratings are typically characterized by a linear increase in grating reflectivity with an increase in laser energy up to a threshold, beyond which, the process transitions into the regime of Type 2 grating formation through highly nonlinear changes to the UV light induced index modulation.

As a result of these and other features described herein, the present techniques overcome technical challenges associated with manufacturing Bragg gratings in optical fibers, particularly the challenge of achieving precise grating placement to avoid regions of unacceptably low reflectivity. The present techniques maintain the reflectivity in overlap regions within acceptable bounds by controlling the ratio of reflectivity amplitudes between adjacent overlapping gratings, thereby improving manufacturing yield and sensor performance. For example, a grating writing system described herein may include a control system configured to control a laser source and to cause a positioning system to adjust at least one pose parameter of an optical fiber, the laser source, and/or an optical component associated with the laser source. The systems described herein may further direct a first ultraviolet light pulse emitted by the laser source to interact with a first portion of the optical fiber to alter a reflectivity of the first portion by a first amplitude and a second ultraviolet light pulse emitted by the laser source to interact with a second portion of the optical fiber to alter a reflectivity of the second portion by a second amplitude. The first portion may partially overlap with the second portion in an overlap region, and a ratio of the first amplitude in the overlap region and the second amplitude in the overlap region may be nonzero. This overlapped grating writing technique yields improvements in manufacturing yield and sensor signal quality that many techniques fail to achieve.

As mentioned, many techniques for manufacturing Bragg grating arrays (e.g., continuous arrays) attempt to write each grating in a precise sequential location relative to other gratings, with the goal of achieving no gap between adjacent gratings and no overlap between adjacent gratings. Ideally, gratings would be perfectly abutted to one another at the same laser energy, with the system firing each laser pulse exactly one grating width away from the previous pulse. However, this is difficult to achieve in practice due to manufacturing tolerances and process variations. The precision required to accurately place gratings to much less than λ/4n (where λ is the wavelength of the reflected light and n is the effective index of refraction of the fiber) is highly demanding. Example values of interest in certain types of high-resolution sensing include λ/4n being approximately 200 nm to 300 nm, such as around 200 nm, 225 nm, 250 nm, 275 nm, or 300 nm.

As many techniques fail to achieve such high precision, gaps or overlaps between adjacent gratings inevitably result. Gaps lead to regions with no effective sensor signal, as the reflectivity in a gap region is effectively zero. Namely, a reflectivity of zero due to an out-of-phase overlap of gratings produces a region of the core where no sensor signal can be obtained through reflection, which is functionally equivalent to having a gap and is unacceptable for many sensing applications. In regions where two gratings of the same nominal reflectivity overlap, the resulting reflectivity depends on the phase relationship between the gratings and can range from zero to twice the nominal reflectivity. However, a reflectivity of twice the nominal value due to an in-phase overlap of gratings produces a region of the core where the sensor signal may be stronger than in adjacent regions, which can introduce non-uniformity in the signal response along the length of the fiber sensor. This randomness caused by overlapping gratings with equal amplitudes thus creates a substantial probability of unintended reflectivity values in overlap regions, negatively affecting manufacturing yield and sensor performance.

The present techniques overcome these challenges by intentionally overlapping gratings in a controlled manner to maintain reflectivity in overlap regions within acceptable thresholds. Rather than attempting to achieve perfect grating placement with no overlap (e.g., and risk creating a gap between adjacent regions), the present techniques embrace controlled overlap while managing the reflectivity ratio between adjacent gratings. Specifically, the control systems described herein cause a first ultraviolet light pulse emitted by the laser source to be directed to interact with a first portion of the optical fiber to alter a reflectivity of the first portion by a first amplitude and a second ultraviolet light pulse emitted by the laser source to be directed to interact with a second portion of the optical fiber to alter a reflectivity of the second portion by a second amplitude. The first portion partially overlaps with the second portion in an overlap region and a ratio of the first amplitude in the overlap region and the second amplitude in the overlap region is nonzero. Thus, the present techniques ensure the resulting reflectivity remains within acceptable bounds even when the gratings overlap with random phase relationships. For example, when the amplitude ratio is 0.5 (i.e., one grating has half the reflectivity of the adjacent grating), the range of resulting refractive index modulation in the overlap region is necessarily between 1.5 and 0.5 times the nominal value, rather than between 2.0 and 0.0, as occurs with equal amplitude gratings. This approach thereby maximizes the minimum reflectivity over an array of gratings and consequently maximizes the minimum signal-to-noise ratio (SNR), directly improving sensor performance.

The present techniques further improve manufacturing yield through various mechanisms to efficiently write adjacent grating with controlled reflectivity ratios. For example, the control system may be configured to cause the laser source to emit the first ultraviolet light pulse and the second ultraviolet light pulse during a single writing pass along the optical fiber, which eliminates the multiple writing pass approach of many manufacturing techniques. The present techniques also include various mechanisms for achieving different energy values between pulses, including controlling the output energy of the laser source directly and/or temporally coordinating the laser source with energy changing components such as attenuators, filter wheels, and/or filter mounting mechanisms attached to damped resonant structures. These various approaches provide implementation flexibility while still controlling reflectivity ratios in the optical fiber overlap regions.

In certain embodiments, the present techniques incorporate feedback components configured to generate a signal indicative of a reflectivity of a grating currently being written or previously written, providing real-time process control to enhance sensor quality and performance. A feedback component of the present disclosure may monitor grating reflectivity during the writing process, and the control systems described herein may dynamically adjust the pose parameter or change an output energy of the laser source based on the signal. This ensures each grating achieves its target reflectivity amplitude and the ratio between adjacent overlapping gratings remains within acceptable bounds. As a result, this closed-loop feedback mechanism corrects process variations in real-time, preventing the accumulation of errors that could otherwise result in regions of unacceptably low reflectivity along the fiber sensor length, which many techniques struggle to achieve.

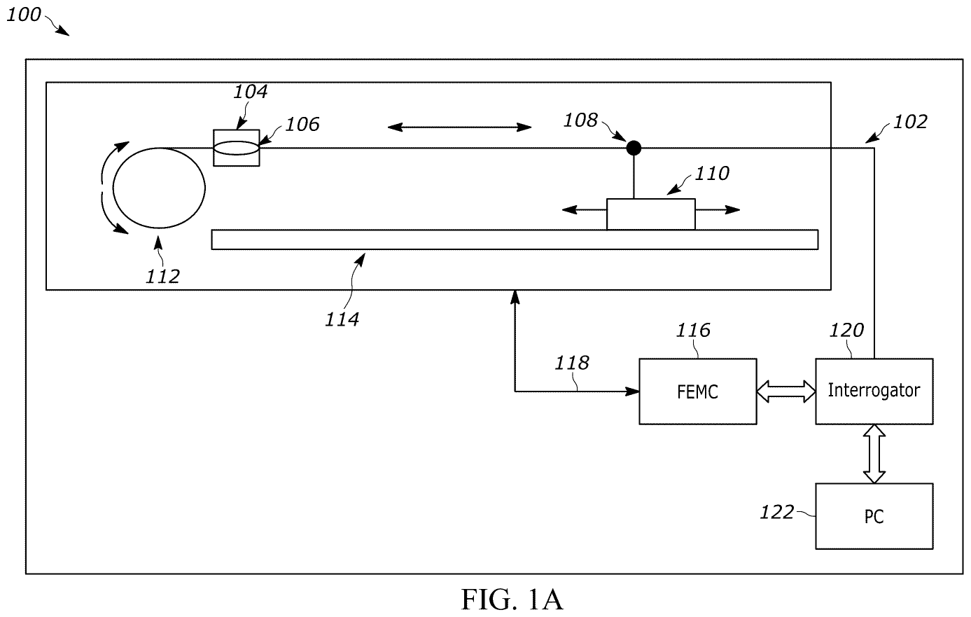

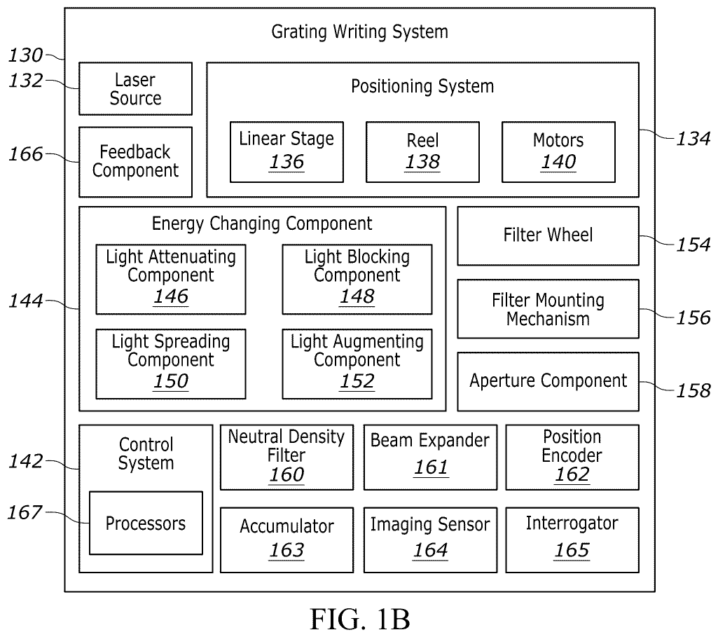

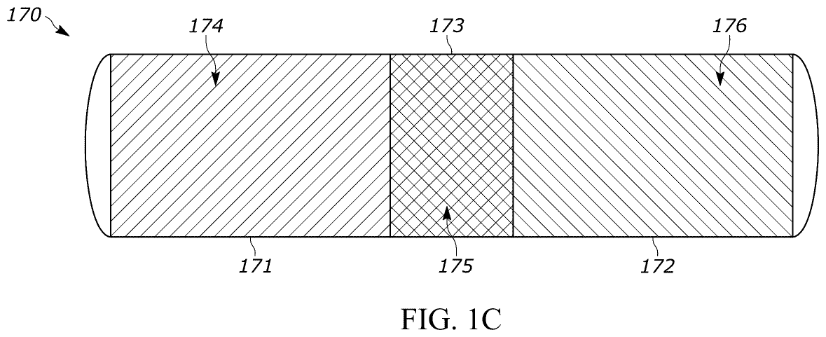

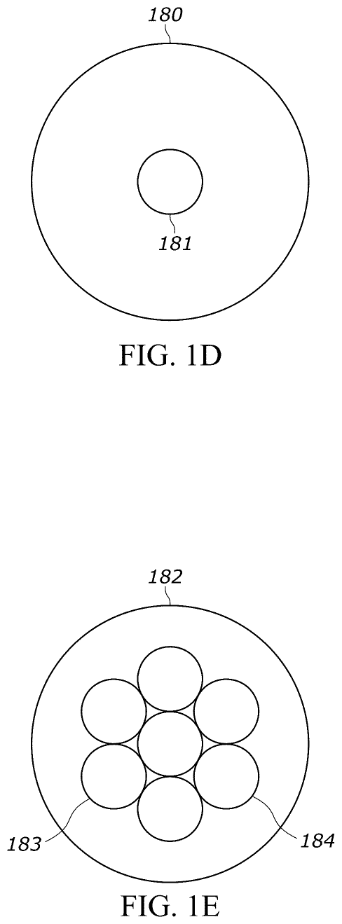

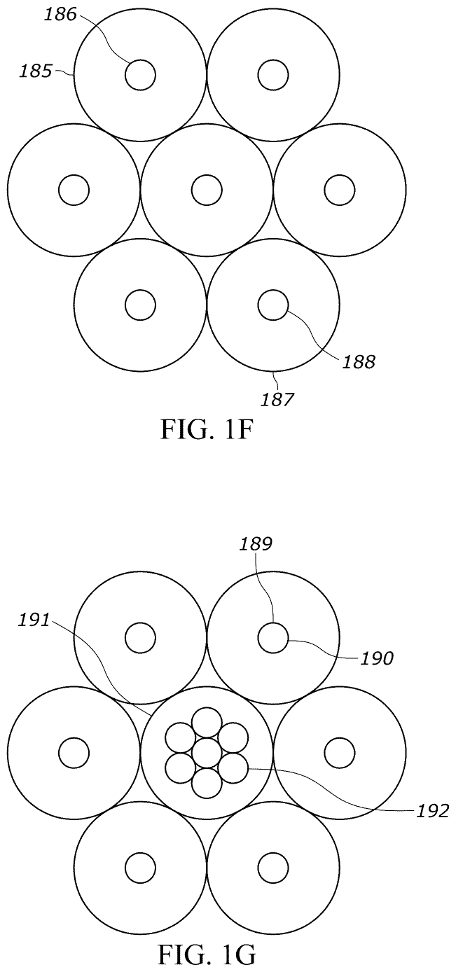

FIG. 1A depicts an example grating writing system 100 for writing gratings in an optical fiber 102. The grating writing system 100 may be configured to inscribe fiber Bragg gratings and/or other optical features into one or more cores of the optical fiber 102 by selectively applying UV light to cause controlled changes in indices of refraction within the optical fiber 102. The grating writing system 100 addresses technical challenges associated with achieving precise grating placement to avoid regions of unacceptably low reflectivity by controlling the ratio of reflectivity amplitudes between adjacent overlapping gratings, as described herein.

While the inherent Rayleigh scatter from the fiber sensor can be used for fiber measurements, the increased SNR from UV laser inscribed Bragg reflectors improves performance. The system 100 depicted in FIG. 1A shows an arrangement for inscribing Bragg gratings in a multicore fiber (a single fiber with multiple cores, or a bundle of single core fibers fixed to each other), although this technique can also be used for inscribing Bragg gratings in a single core fiber. A linear stage 110 couples to the optical fiber 102 by holding a connector 108 attached to the multicore fiber. The linear stage 110 can move the optical fiber 102 along an axis, and position the desired part of the optical fiber 102 in front of a phase mask 104 or interferometer. The phase mask 104 or interferometer creates the interference pattern to be inscribed. A laser (not shown) is configured to emit UV light, which is generally represented by the laser beam outline 106, and the emitted beam is directed at the phase mask 104. A reel 112 takes up the slack in the optical fiber 102 and maintains the proper distance to the optical fiber 102 from the phase mask 104.

The grating writing system 100 includes a positioning system configured to adjust at least one pose parameter selected from the group consisting of: a position of the optical fiber 102, an orientation of the optical fiber 102, a position of a part of the laser, an orientation of the part of the laser, a position of an optical component associated with the laser, or an orientation of the optical component. The positioning system may comprise the linear stage 110 configured to be coupled to a first end portion of the optical fiber 102 and the reel 112 on which a second end portion of the optical fiber 102 is to be wrapped. The linear stage 110 is positioned on a track 114 that enables controlled movement of the optical fiber 102 along a linear axis.

The grating writing system 100 further includes a control system comprising one or more processors, the one or more processors comprising circuitry. The control system may be configured to coordinate motion of the linear stage 110 and the reel 112 via motors to adjust the position of the optical fiber 102. The motors used for coordinating linear stage 110 and reel 112 motions can be stepper motors. The motors, as controlled by the control system, may coordinate the linear stage 110 and reel 112 motions in a feedback loop with control inputs provided by encoders, accumulators, interrogator measurements, imaging sensors, and/or other sensors and data.

The grating writing system 100 includes a feedback component 116 that communicates with an interrogator 120 through feedback and control signals 118. The interrogator 120 may be configured to provide optical measurements and process control parameters for the grating writing process. A computing device 122 may be connected to the interrogator 120 to provide additional processing capabilities and control/feedback functions. The feedback component 116, interrogator 120, and computing device 122 may collectively form the control system that coordinates the operation of the laser and the positioning of the optical fiber 102 via the linear stage 110 and reel 112 to achieve precise placement of gratings within the optical fiber 102.

In certain embodiments, the feedback component 116 may be or include a Fiber Extensible Motor Controller (FEMC) synchronized with the interrogator 120 to provide control loops with various feedback rates (e.g., 100 Hz, 200 Hz, 300 Hz, etc.). The FEMC capabilities may include strain gages, analog and digital i/o, stepper motors, and high voltage piezo control. This feedback component 116 may further include other components, such as analog-to-digital converters (ADCs), digital-to-analog converters (DACs), processing components (e.g., field-programmable gate arrays (FPGAs)), and/or other components to support common interface hardware and protocols that may be utilized as part of the systems described herein. The interrogator 120 may be an optical frequency domain reflectometry (OFDR) system.

An example process for creating a fiber sensor is to move the optical fiber 102 in discrete steps, each step approximately the laser beam width, and firing the laser between each step (while the optical fiber 102 is stationary) to achieve a continuous length of inscribed Bragg gratings. Using the feedback controlled actuators, very precise positioning of the Bragg gratings, and thus control of these gratings' properties, can be achieved. Alternatively, the optical fiber 102 can be continuously moving during grating writing with laser pulses applied periodically as an appropriate amount of fiber has passed. In this configuration, the control system controls the laser firing and fiber movement such that each grating is written in a precise sequential location relative to the other gratings.

FIG. 1B depicts an example grating writing system 130 for writing gratings in an optical fiber. The example grating writing system 130 includes a laser source 132 configured to emit UV light. The laser source 132 may be a krypton fluoride (KrF) pulsed excimer laser operating nominally at approximately 250 nm with pulse lengths on the order of 10 nanoseconds (ns). In some examples, the laser source 132 may have a cavity design such that the coherence length is sufficiently controlled to allow the formation of an appropriate UV interference pattern of the emitted beam. The source 132 may emit pulses having a pulse energy of any suitable values, such as between about 6 and 15 millijoules (mJ), and the laser source 132 may emit such pulses with repetition rates at any suitable value(s), such as 250 Hz. The laser beam size may be rectangular and may have an exit port beam size of approximately 3×6 millimeters (mm) and a divergence of about 1×2 milliRad (mRad).

In some aspects, one or more of the components depicted in FIG. 1B may be included as part of one or more other components depicted in FIG. 1B, and the depiction of these components as separate elements is for purposes of discussion only. For example, the feedback component 166, in certain embodiments, may be or include the interrogator 165, such that the interrogator 165 provides the signal indicative of the reflectivity of a grating currently being written or previously written. As another example, the light spreading component 150 may be or include the beam expander 161, such that the beam expander 161 functions as the energy changing component 144 by spreading the UV light over a larger area to reduce fluence at the optical fiber. Similarly, the light attenuating component 146 may be or include the neutral density filter 160, and the aperture component 158 may function as the light blocking component 148 by selectively blocking portions of the beam profile. The control system 142 may be or include the processors 167, and the positioning system 134 may encompass the linear stage 136, the reel 138, and the motors 140 as an integrated unit or as separate cooperating elements. These relationships between components may vary depending on the particular implementation and configuration of the grating writing system 130.

The example grating writing system 130 includes a positioning system 134 configured to adjust at least one pose parameter selected from the group consisting of: a position of the optical fiber, an orientation of the optical fiber, a position of a part of the laser source 132, an orientation of the part of the laser source 132, a position of an optical component associated with the laser source 132, or an orientation of the optical component. The positioning system 134 may comprise a linear stage 136 configured to be coupled to a first end portion of the optical fiber and a reel 138 on which a second end portion of the optical fiber is to be wrapped. The positioning system 134 may further comprise motors 140 configured to coordinate motion of the linear stage 136 and the reel 138 to adjust the position of the optical fiber during the grating writing process. In certain embodiments, the motors 140 may be stepper motors.

The example grating writing system 130 includes a control system 142 comprising processors 167. The processors 167 may comprise circuitry for controlling the laser source 132 and the positioning system 134. The control system 142 may be configured to control the laser source 132 and to cause the positioning system 134 to adjust the at least one pose parameter such that (i) a first UV light pulse emitted by the laser source 132 is directed to interact with a first portion of the optical fiber to alter a reflectivity of the first portion by a first amplitude and (ii) a second UV light pulse emitted by the laser source 132 is directed to interact with a second portion of the optical fiber to alter a reflectivity of the second portion by a second amplitude. The first portion may partially overlap with the second portion in an overlap region, and a ratio of the first amplitude in the overlap region and the second amplitude in the overlap region may be nonzero. In certain embodiments, the control system 142 may be configured to coordinate motion of the linear stage 136 and the reel 138 via the motors 140 to adjust the position of the optical fiber to create the overlap region within the optical fiber.

In some embodiments, the control system 142 may be configured to provide the first ultraviolet light pulse at a first energy value and the second ultraviolet light pulse at a second energy value that is different from the first energy value. To provide the first ultraviolet light pulse at the first energy value and the second ultraviolet light pulse at the second energy value, the control system 142 may be configured to control an output energy of the laser source 132. The control system 142 may be configured to cause the laser source 132 to provide a sequence of UV light pulses alternating between first and second energy values. The sequence of ultraviolet light pulses may comprise the first ultraviolet light pulse and the second ultraviolet light pulse, wherein the first ultraviolet light pulse has the first energy value and the second ultraviolet light pulse has the second energy value.

The energy changing component 144 may comprise a light attenuating component 146, a light blocking component 148, a light spreading component 150, or a light augmenting component 152. In certain embodiments, the control system 142 may be configured to temporally coordinate the laser source 132 with the energy changing component 144 by synchronously triggering ultraviolet light emission from the source 132 with activation or actuation of an energy changing component 144.

In certain embodiments, the light attenuating component 146 may be or include a neutral density filter (e.g., 160), a gradient neutral density filter, a variable optical attenuator, a polarizer-based attenuator, a liquid crystal attenuator, and/or an acousto-optic modulator configured to reduce the intensity of the UV light pulses. The light blocking component 148 may be or include a mechanical shutter, a rotating chopper wheel, an electro-optic shutter, a fast-acting piezoelectric shutter, a galvanometer-driven mirror, and/or a beam dump configured to selectively block or redirect portions of the UV light pulses. The light spreading component 150 may be or include a diverging lens, a diffuser element, a beam expander, a holographic diffuser, a ground glass element, an adjustable telescope arrangement, and/or a defocusing mechanism configured to spread the UV light over a larger area to reduce fluence at the optical fiber. The light augmenting component 152 may be or include a focusing lens, a beam concentrator, a cylindrical lens, a parabolic mirror, a compound lens system, an adaptive optic element, and/or a reflective element configured to increase the fluence of the UV light at the optical fiber.

The grating writing system 130 may further include a filter wheel 154. To provide the first UV light pulse at the first energy value and the second UV light pulse at the second energy value, the control system 142 may be configured to temporally coordinate the laser source 132 providing UV light with a rotation of the filter wheel 154 to selectively position one or more filters of the filter wheel 154 in an optical path of the UV light. An example filter wheel 154 may be configured with a number of sets of transmission filters with different transmission ratios (e.g., 100% transmission and 50% transmission, in an example with ratio 0.5). The filter wheel 154 may be rotated with the laser firings, such that adjacent gratings are written with different laser power. In some examples, more filter sets included in the filter wheel 154 may reduce the rate at which the filter wheel 154 is rotated.

The grating writing system 130 may include a filter mounting mechanism 156 configured to attach one or more filters to a damped resonant structure. In certain embodiments, the control system 142 may be configured to temporally coordinate the laser source 132 providing UV light with a position adjustment to the damped resonant structure to selectively position the one or more filters in an optical path of the UV light to provide the first UV light pulse at the first energy value and the second UV light pulse at the second energy value.

Generally, there are many ways to alternate the laser energy between the laser pulses used to write gratings. One way is to change the laser energy for each grating, such as cycling between the nominal value and another value (e.g., half the nominal value). In an example, the speed with which the fiber moves is coordinated with how rapidly the laser energy changes to produce the desired application of UV light and resulting grating features. In an example system, the position encoder 162 placed to sense a position of a linear actuator (e.g., linear stage 136) that moves the fiber, or the reel 138 that uptakes or rolls out fiber, may be configured to provide a signal to fire the laser source 132 at the appropriate times. This signal may also be used to alternate the laser energies at the appropriate times. In another example system, a sensor may be configured to detect the position or velocity (or component thereof, such as speed) of the fiber, or a proxy for the position of the fiber (e.g., a position of a reel or sled coupled to the fiber); a processing system may process the sensor signals and control the laser firing.

If the laser source 132 has a limit on how fast the energy settings can be changed that limits the required production rate, one or more other techniques of changing the laser energy level can be used instead or in addition. An example technique is to make multiple writing passes along the array. For example, for a first pass, the laser energy may be set to the nominal level; then, for a second pass, the laser energy may be set to other than the nominal level (e.g., set to half the nominal value, in an example with ratio 0.5). Another example technique is to use a solid-state attenuator that is switched with alternating laser firing, to alternate between different levels of attenuation (e.g., 0% attenuation for a nominal energy, and 50% attenuation for half the energy, in an example with ratio 0.5). Solid-state attenuators are capable of changing states very rapidly.

Another example technique synchronizes the filter wheel 154 with the laser firing. An example filter wheel 154 may be configured with a number of sets of transmission filters with differing transmission ratios (e.g., 100% transmission and 50% transmission, in an example with ratio 0.5). The filter wheel 154 may be rotated with the laser firings, such that adjacent gratings are written with different laser power. In an example, more filter sets included in the filter wheel 154 may reduce the rate at which the filter wheel 154 is rotated. Another example technique involves mounting different transmission filters on a damped resonant structure using the filter mounting mechanism 156 that could be synchronized with the laser firing. Different transmission filters may be applied to the laser beam for adjacent gratings, such that adjacent gratings are written with different laser power. Any other method that uniformly attenuates the laser energy is contemplated. Further, these example techniques attenuate the laser energy to achieve the desired ratio. Other example techniques increase the laser energy to achieve the desired ratio.

As an example using multiple writing passes, the grating writing system 130 may perform a first writing pass along a 1 meter optical fiber with the laser source 132 emitting pulses at 15 mJ to write gratings at positions of 0 mm, 8 mm, 16 mm, and so forth along the fiber length. The control system 142 may then cause the positioning system 134 to return the optical fiber to the starting position and perform a second writing pass with the laser source 132 emitting pulses at 7.5 mJ to write gratings at positions 4 mm, 12 mm, 20 mm, and so forth, creating overlap regions of approximately 2 mm between adjacent gratings from the first and second passes with a reflectivity ratio of 0.5.

Another approach that can replace, or supplement, alternating the laser power from grating to grating is to write the grating with a slope to the grating reflectivity over the length of the grating. The slope of the grating reflectivity is generally related to the slope of the spatial refractive index power profile of the grating. This spatial refractive index power profile may be understood as the strength or efficiency of the grating in affecting light passing through it along the length of the grating, and is determined by the slope of the spatial energy profile of the UV light used to write the grating. A steeper slope in the UV light's energy profile may result in a more pronounced change in the refractive index across the grating, leading to a lower grating reflectivity on the lower end of the sloped profile. This can result in an overlap region between two gratings that has a reflectivity ratio that substantially deviates from 0.5. Conversely, a gentler slope may result in a more gradual change in refractive index, leading to a less pronounced grating reflectivity drop on the lower end of the sloped profile, and thereby more likely avoiding the condition where the reflectivity ratio of overlapping gratings has a value that substantially deviates from 0.5.

As an example, the grating writing system 130 may use the neutral density filter 160 with a linear transmission gradient from 100% to 50% positioned in the optical path of the UV light pulses. The neutral density filter 160 may be oriented such that the higher transmission portion corresponds to a first end of each grating and the lower transmission portion corresponds to a second end of each grating. The control system 142 may cause the positioning system 134 to position the optical fiber such that the second end of each grating (with lower reflectivity) overlaps with the first end of the adjacent grating (with higher reflectivity). This arrangement may produce overlap regions where the reflectivity ratio remains close to 0.5 without requiring alternation of laser energy between successive pulses.

The grating writing system 130 may further include an aperture component 158 configured to block a part of a beam profile of the UV light pulses emitted by the laser source 132. The aperture component 158 may be located to transmit a sub-region of a beam profile of the UV light pulses, the sub-region having a uniformity value that is higher than a uniformity value of the beam profile. The grating writing system 130 may include a neutral density filter 160 positioned in an optical path of the UV light pulses emitted by the laser source 132. The neutral density filter 160 may have a transmission gradient, and the control system 142 may be further configured to adjust an orientation of the neutral density filter 160 to adjust amplitude values of the UV light pulses to create a non-uniform beam profile.

The grating writing system 130 may further include a beam expander 161 configured to expand a beam profile of UV light emitted by the laser source 132. In certain embodiments, the aperture component 158 may be configured to block a part of the expanded beam profile. In some examples, the laser beam diameter may be first increased via the beam expander 161 and the aperture component 158 may pass a region around the peak where the beam profile is more uniform. This approach may help to maintain the grating length and avoid the reduction in potential grating length that can be written by a laser pulse if an aperture is applied without beam expansion.

The grating writing system 130 may further include at least one component selected from the group consisting of: (i) a position encoder 162, (ii) an accumulator 163, (iii) an interrogator 165, and/or (iv) an imaging sensor 164. The at least one component may be configured to provide data for the control system 142 to temporally coordinate firing of the laser source 132 and/or to adjust an output power of the laser source 132. For example, the position encoder 162 may be placed to sense a position of a linear actuator that moves the fiber or to sense the position/rotation a reel that uptakes or rolls out the fiber. The position encoder 162 may be configured to provide a signal to fire the laser source 132 at the appropriate times, and this signal may also be used to alternate the laser energies at the appropriate times.

As other examples, the accumulator 163 may be configured to track cumulative fiber displacement or pulse counts during the grating writing process. The accumulator 163 may provide data to the control system 142 to determine when a sufficient amount of fiber has passed to trigger the next laser pulse, and this data may also be used to coordinate the alternation of laser energies between successive pulses. The interrogator 165 may be configured to measure optical properties of the gratings as they are written or after they have been written. The interrogator 165 may provide feedback signals to the control system 142 indicating grating reflectivity or spectral characteristics, and these signals may be used to adjust the timing of laser firings or to modify the laser energy values to achieve target reflectivity amplitudes. The imaging sensor 164 may be configured to capture images of the optical fiber, the laser beam profile, and/or the grating writing region. The imaging sensor 164 may provide visual data to the control system 142 for monitoring fiber position, beam alignment, and/or grating quality, and the control system 142 may use this data to cause the positioning system 134 to adjust the pose of the laser source 132 and/or other components and/or to adjust output parameters of the laser source 132.

The grating writing system 130 further includes a feedback component 166 configured to provide a signal indicative of a reflectivity of a grating currently being written or previously written. In certain embodiments, the feedback component 166 may be or include and/or otherwise communicate with the interrogator 165 to provide optical measurements and process control parameters for the grating writing process. The fiber optic measurements available via the interrogator 165 may provide process control parameters that can be used by software at any level (e.g., PC/LabVIEW, interrogator/C++, FEMC/FPGA) to provide feedback. In certain embodiments, the feedback component 166 may further be or include an FEMC configured to provide control loops with feedback rates of 100 Hz or higher, and/or may interface with strain gages, analog and digital input/output devices, stepper motors, and/or high voltage piezo control systems to provide real-time adjustments for the grating writing process based on the signal indicative of the reflectivity.

FIGS. 1C-1G depict various optical fiber structures and grating overlap configurations. FIG. 1C depicts a longitudinal view of an optical fiber 170 showing overlapping fiber Bragg gratings with different reflectivities. The optical fiber 170 may comprise a strand of glass or plastic configured to guide light along its length. The optical fiber 170 includes a first portion 171 and a second portion 172 that at least partially overlap in an overlap region 173. A first grating 174 is disposed in the first portion 171, and a second grating 176 is disposed in the second portion 172. The first grating 174 and the second grating 176 are represented by diagonal hatching patterns within their respective portions 171 and 172, respectively, of the optical fiber 170.

In the overlap region 173, the overlapped grating 175 is formed as a result of the first grating 174 and the second grating 176 intersecting/overlapping. The overlapped grating 175 is represented by a cross-hatched pattern indicating the superposition of both gratings 174 and 176. The first grating 174 may alter a reflectivity of the first portion 171 by a first amplitude compared to a reflectivity of the strand without any gratings, and the second grating 176 may alter a reflectivity of the second portion 172 by a second amplitude compared to a reflectivity of the strand without any gratings. A ratio of the first amplitude and the second amplitude in the overlap region 173 is nonzero. In certain embodiments, the first grating 174 may have a first spatial reflectivity profile and the second grating 176 may have a second spatial reflectivity profile, wherein a first value of the first spatial reflectivity profile in the overlap region 173 differs from a second value of the second spatial reflectivity profile in the overlap region 173, and wherein the first and second values are nonzero.

Various cross-sectional configurations of optical fibers suitable for use with the grating writing systems described herein are also shown. For example, FIG. 1D depicts a single-core fiber cross-section 180 showing a cross-sectional view of an optical fiber containing a single core 181 positioned within the fiber structure. The single core 181 may serve as an optical core in which the first grating 174 and the second grating 176 are inscribed to form the overlapped grating 175 in the overlap region 173.

FIG. 1E depicts a multi-core fiber cross-section 182 showing a cross-sectional view of an optical fiber containing multiple cores. The multi-core fiber cross-section 182 includes a first core 183 positioned at a first peripheral position and a second core 184 positioned at a second peripheral position within the fiber. In certain embodiments, the optical fiber 170 may comprise a multi-core fiber with six peripheral cores symmetrically located around a central core and/or any other suitable number and/or configuration of cores. The peripheral cores may be spaced at about 30 microns from the central core but may also be spaced at any suitable distance (e.g., 25, 35, 40, 45, 50, and/or 100 microns) from the central core. The peripheral cores may rotate/spin around the central core along the length of the fiber sensor, and the fiber sensor may comprise, e.g., 2, 3, 4, 5, 6, or more cores helically or otherwise spun about a central core.

FIG. 1F depicts a cross-sectional view of a bundle of single-core fibers fixed to each other. The first fiber cross-section 185 includes a first fiber single core 186 and a second fiber cross-section 187 includes a second fiber single core 188. In some embodiments, the fiber bundle depicted in FIG. 1F may include seven single-core fibers, but it should be understood that the configuration may include any suitable number of single-core fibers, such as 2, 3, 4, 5, 6, 7, and/or any other suitable number. In this configuration, each of the single-core fibers may have gratings inscribed therein, and the bundle of fibers may function collectively as a fiber sensor for shape sensing or other applications.

FIG. 1G depicts a cross-sectional view of a hybrid fiber configuration combining one or more single-core fibers with one or more multi-core fibers. This configuration includes a first single-core fiber cross-section 189 having a first fiber single core 190 positioned within one of the peripheral single-core fibers. A central multi-core fiber 191 is positioned at the center of the configuration and contains a plurality of cores 192. This hybrid configuration may provide flexibility in sensor design by combining the characteristics of single-core and multi-core fibers.

In certain embodiments, an optical fiber sensor may comprise a fiber containing a plurality of cores (e.g., in FIG. 1E), a plurality of single-core fibers fixed to each other (e.g., in FIG. 1F), or a fiber containing a plurality of cores fixed to at least one single-core fiber (e.g., in FIG. 1G). Each of these configurations may incorporate the overlapped grating 175 with controlled reflectivity ratios, as described herein.

More generally, the fibers used for shape sensing described herein can have a variety of coatings and/or other suitable configurations. For example, where the fiber optic coating used is opaque to UV light at the laser writing frequency, the grating writing process may include further steps to strip the coating before writing the grating, and then recoating the fiber after writing the grating. Where the fiber optic coating used is sufficiently transparent to UV light at the laser writing frequency to allow proper grating writing, such coating need not be stripped before grating writing. Example coatings that may be sufficiently transparent to UV light at the laser writing frequency include types of silicones and fluoroacrylates and acrylates. Silicones and fluoroacrylates have refractive indices below that of fused silica, and will allow cladding modes to propagate. Acrylates have refractive indices above that of fused silica and will suppress cladding modes. While both conditions can be made to work, suppression of cladding modes can be more desirable in various instances.

Additionally, pure silicone is soft and tacky to the touch, and generally sticks to other materials and does not slide smoothly across any guide mechanisms. This makes handling silicone difficult and subject to damage. Additional coatings can be applied over silicone to mitigate this tackiness. An example coating is parylene. Another example is to apply a thin layer of acrylate over silicone. A further example is to apply a thin layer of acrylate, without an underlying silicone layer. Some acrylates, applied in thin enough layers, are sufficiently UV transparent to allow grating inscription. The performance, durability, friction characteristics, biocompatibility, and other characteristics of the coatings vary. Further, the sensor may be annealed after the grating writing process is complete.

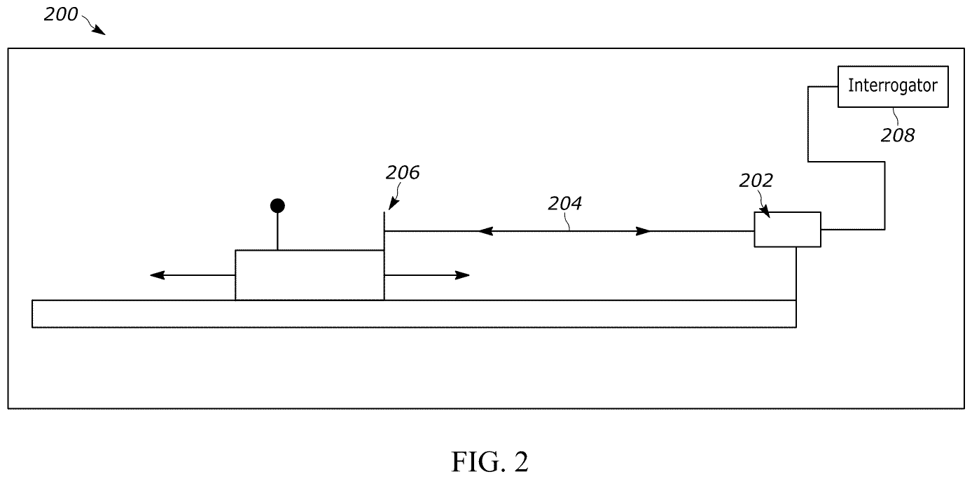

FIG. 2 depicts an interrogator ranging system 200 configured to provide free space laser ranging capability. In some embodiments, the interrogators described herein (e.g., 120, 165) may be configured to provide this free space laser ranging capability. The interrogator ranging system 200 includes a fiber collimator 202, a free space beam 204, a reflecting surface 206, and an interrogator 208. The fiber collimator 202 may be fixed to one end of a track (e.g., 114) and pointed at the reflecting surface 206 attached to a linear stage (e.g., 110) or other component whose position is to be monitored during the grating writing process, such as a reel or a component holding the phase mask. The free space beam 204 represents the optical path between the fiber collimator 202 and the reflecting surface 206, with light traveling in both directions along this path. In certain embodiments, the reflecting surface 206 is or includes a retro-reflector, a diffuse reflecting surface, a specular reflecting surface, and/or any other suitable reflective component or combinations thereof.

The interrogator 208 may be connected to the fiber collimator 202 via an optical fiber connection and may be configured to transmit light through the fiber collimator 202 and receive reflected light returning from the reflecting surface 206. Some of the light reflected back from the reflecting surface 206 may be captured and can be treated as if the reflecting surface 206 was a moving reflector in fiber with an index of unity. The fiber collimator 202 may be arranged to have a partial reflection at an end-face of the fiber collimator 202. The spacing between reflections from the end-face and the reflecting surface 206 may be used to compute the location of the linear stage with respect to the end-face of the fiber collimator 202. This signal may be readily captured by the interrogator 208 and used for process control during the grating writing process.

The interrogator ranging system 200 may be applied to monitor various positions and motions within the grating writing systems described herein (e.g., 100, 130). For example, the interrogator ranging system 200 may be used to monitor the lateral location of the reel 112 or the reel 138, the vertical location of the connector 108, and/or the motions of the phase mask 104 during grating writing. In some examples, the interrogator ranging system 200 may be used for range sensing in addition to, or instead of, monitoring these positions.

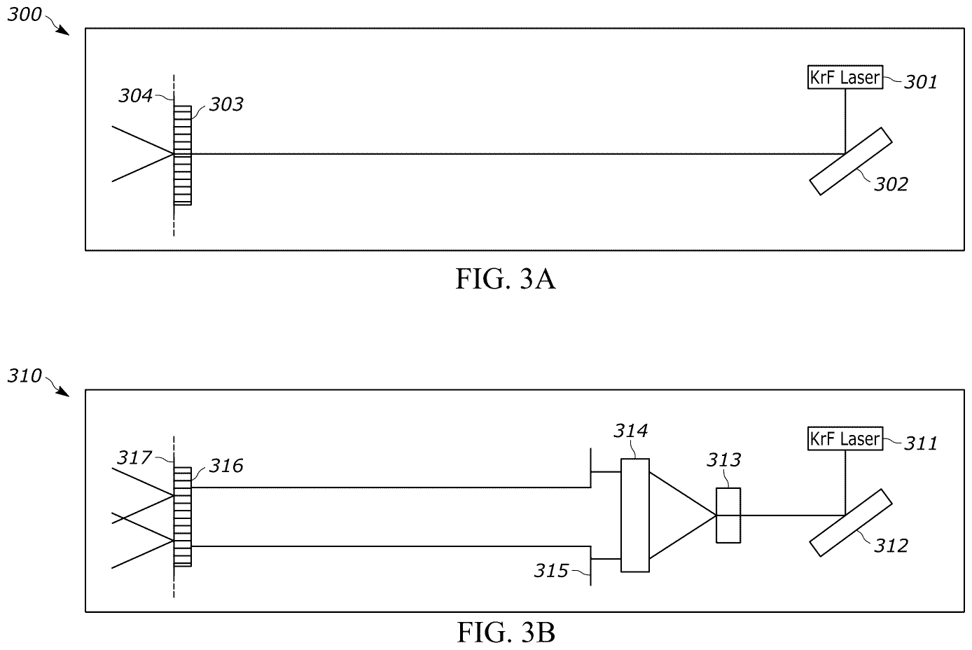

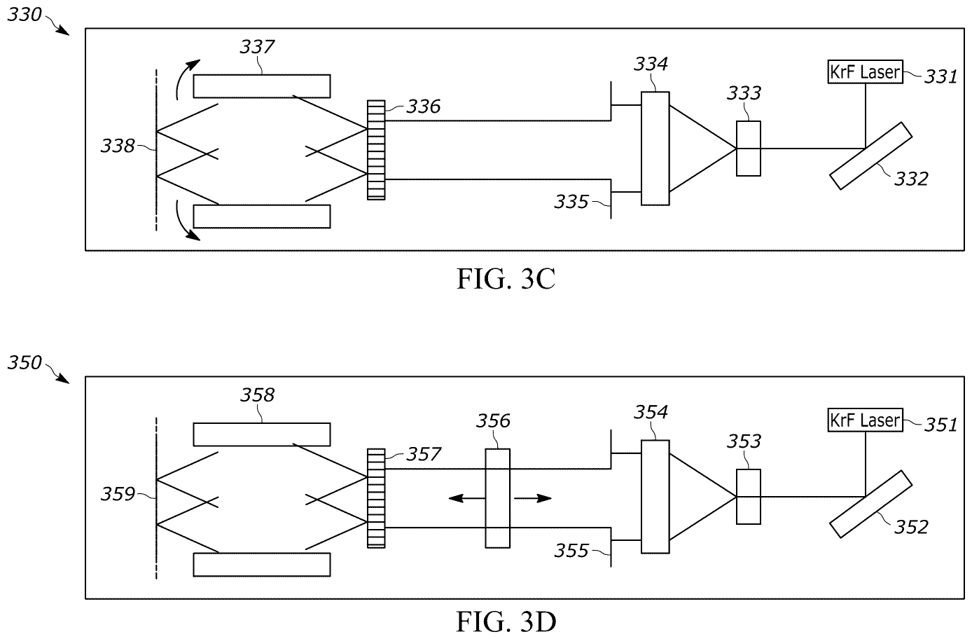

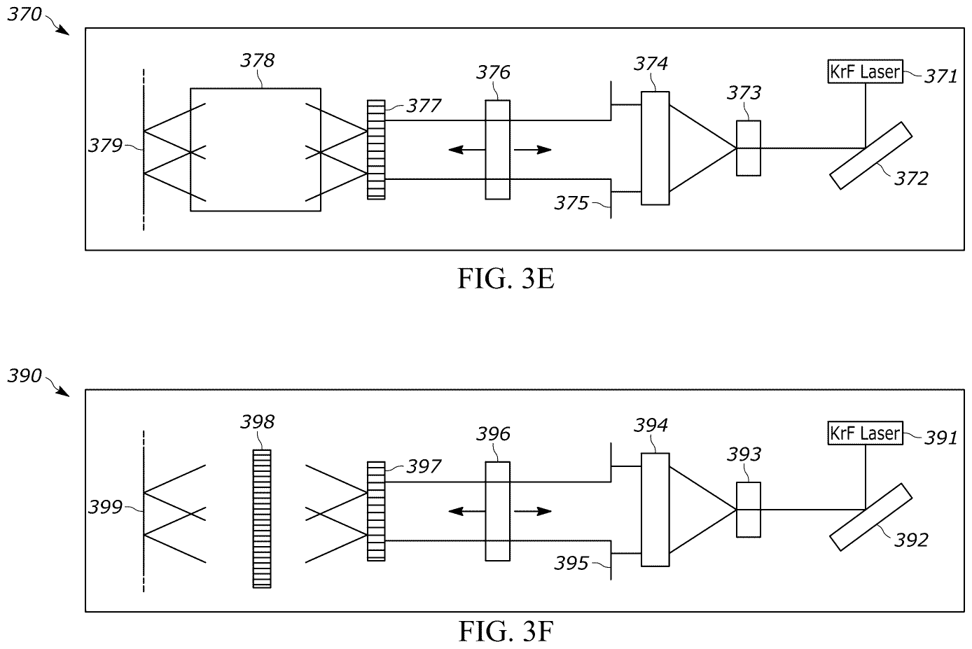

More generally, the optical components described herein can be configured in a variety of ways to inscribe gratings with various properties. For example, FIG. 3A depicts a first example optical component configuration 300 for inscribing gratings in an optical fiber 304. The first example optical component configuration 300 shows a laser beam from a laser 301, which may be a KrF laser, reflected from a mirror 302, and directed through a phase mask 303, and onto the optical fiber 304 disposed adjacent to the phase mask 303. It should be appreciated that, in certain embodiments, the configuration 300 may not include the mirror 312, and other similar configurations (e.g., 310, 330, etc.) may not include corresponding mirrors depicted therein (e.g., mirror 312, 332, etc.).

The laser beam is shown as a thin line from the laser 301, turning to the left at the mirror 302, and spreading outwards toward the left side of the figure after emerging from the phase mask 303. The grating size may be governed by the beam size and the reflection profile may be shaped by the Gaussian-like beam profile. As referenced herein, the beam profiles of emitted laser pulses may be “Gaussian-like”, at least in that the beam profiles are similar to a true Gaussian profile. For example, an excimer laser of the present systems may emit laser pulses having a top-hat profile in one direction and a relatively elliptical profile in the orthogonal direction. This elliptical profile is similar to a Gaussian profile, such that “Gaussian-like” profiles referenced herein may correspond to an elliptical or other similar profile shape.

The location of the phase mask 303 with respect to the optical fiber 304 may influence the resulting gratings. If the phase mask 303 is touching the optical fiber 304 then the overlap of the two diverging beams may be maximized as may be the fringe contrast in the inscribing beam. The fringe contrast may be a maximum because the spatial coherence between the beams is also a maximum when the beams are closest to overlapping perfectly.

In an example implementation, the laser 301 may emit UV light at approximately 250 nm wavelength with a rectangular beam profile of approximately 3×6 mm and the mirror 302 may redirect the laser beam toward the phase mask 303, which creates an interference pattern from the incoming UV light beam. The interference pattern exits the phase mask 303 as diverging beams that interact with the optical fiber 304 to inscribe gratings by causing controlled changes in the indices of refraction within the fiber cores. In this configuration, the grating length corresponds to the beam width along the fiber axis, and the reflectivity profile of the resulting grating follows the Gaussian-like intensity distribution of the laser beam.

FIG. 3B depicts a second example optical component configuration 310 similar to that shown in FIG. 3A and with an up-collimator and an aperture 315 added. The second example optical component configuration 310 includes a laser 311 that emits UV light, a mirror 312 that redirects the laser beam, a first lens 313 and a second lens 314 that together form the up-collimator, the aperture 315, a phase mask 316, and an optical fiber 317. These additions facilitate selection of the beam size on the optical fiber 317, may increase beam power uniformity, may decrease the irradiance at the optical fiber 317, and may increase the spatial coherence length. An anamorphic prism pair to allow beam expansion in one dimension could be used in place of the up-collimator formed by the first and second lenses 313 and 314.

As mentioned, in the second example optical component configuration 310, the first lens 313 and the second lens 314 function as an up-collimator (e.g., a beam expander) configured to expand a beam profile of UV light emitted by the laser 311. The aperture 315 may be configured to block a part of the expanded beam profile. The aperture 315 may be located to transmit a sub-region of the beam profile of the UV light pulses, and the sub-region may have a uniformity value that is higher than a uniformity value of the beam profile. For example, the degree of windowing of the laser beam can be selected to achieve uniformities of about 70% or 90%, depending on the application requirements. The conditioned beam then passes through the phase mask 316, which creates an interference pattern directed onto the optical fiber 317 for inscribing gratings.

As an example, the laser 311 may emit a UV beam with a Gaussian-like intensity profile. The first lens 313 may be a diverging lens and the second lens 314 may be a converging lens, arranged to expand the beam diameter by a factor of two or more. The aperture 315 may then pass a central portion of the expanded beam where the intensity is more uniform, blocking peripheral portions where the Gaussian-like profile falls off. This approach may help maintain the grating length and avoid the reduction in potential grating length that can be written by a laser pulse if an aperture is applied without beam expansion. The resulting beam incident on the optical fiber 317 may have a more uniform spatial energy profile, producing gratings with more uniform reflectivity profiles along their length.

In certain embodiments, the aperture 315 may be incorporated into an interferometer, such as being integrated with a component containing the phase mask 316. In some examples, the aperture 315 may be placed between the interferometer and the optical fiber 317 containing the cores in which gratings are to be written. The positioning of the aperture 315 relative to other optical components may be selected based on the desired beam characteristics and grating properties for a particular application.

FIG. 3C depicts a third example optical component configuration 330 with a direct writing phase mask replaced with a tunable interferometer. The third example optical component configuration 330 includes a laser 331 that emits UV light, a mirror 332 that redirects the laser beam, a first lens 333 and a second lens 334 that together form an up-collimator, an aperture 335, a phase mask 336, a mirror set 337, and an optical fiber 338. In this example, the phase mask 336 is used as a beam splitter. By rotating the mirrors of the mirror set 337, the systems described herein may change the interference pattern spacing, resulting in a change in the wavelength of the inscribed grating. In certain embodiments, the systems described herein may also move the phase mask 336 (e.g., to adjust the interference pattern phase).

The mirror set 337 may include two or more mirrors positioned to receive split beams from the phase mask 336 and redirect the split beams toward the optical fiber 338. The angle of the mirrors in the mirror set 337 determines the angle at which the beams recombine at the optical fiber 338, which in turn determines the period of the interference pattern and the resulting Bragg wavelength of the inscribed grating. Arrows in FIG. 3C indicate the direction of movement capability for the phase mask 336 and the mirror set 337 components. The third example optical component configuration 330 may thereby provide tunability for the grating writing process that is generally unavailable with many direct writing phase mask configurations.

As an example, the laser 331 may emit UV light at approximately 250 nm wavelength, the first lens 333 and the second lens 334 may expand the beam diameter, and the aperture 335 may allow a uniform portion of the expanded beam to pass towards the phase mask 336. The phase mask 336 may split the incoming beam into two diffracted orders that propagate toward the mirror set 337. To inscribe a grating with a Bragg wavelength of 1550 nm in a fiber with an effective refractive index of 1.45, the mirror set 337 may be rotated to produce an interference pattern with a period of approximately 535 nm.

FIG. 3D depicts a fourth example optical component configuration 350, similar to that shown in FIG. 3C with a cylindrical lens added. The fourth example optical component configuration 350 includes a laser 351 that emits UV light, a mirror 352 that redirects the laser beam, a first lens 353 and a second lens 354 that together form an up-collimator, an aperture 355, a third lens 356, a phase mask 357, a mirror set 358, and an optical fiber 359. The third lens 356 is oriented to allow focusing out of the drawing plane. Accordingly, the laser beam may transition from an area to a line coincident on the optical fiber 359. If the third lens 356 is positioned one focal length away from the optical fiber 359, then the laser energy may focus to a line coincident with the optical fiber 359, greatly increasing the fluence at the optical fiber 359. Moving the third lens 356 along the optical axis provides an easy way to change the energy level at the optical fiber 359.

The third lens 356 in the fourth example optical component configuration 350 provides control over the fluence at the optical fiber 359 without changing the laser output energy. A bidirectional arrow in FIG. 3D indicates the adjustable positioning of the third lens 356 along the optical axis. When the third lens 356 is positioned at one focal length from the optical fiber 359, the beam is focused to a line with maximum fluence. When the third lens 356 is moved closer to or farther from the optical fiber 359, the beam spreads out at the fiber location, reducing the fluence. This mechanism may be used in conjunction with the energy changing components described herein (e.g., 144) to achieve the different energy values between the first UV light pulse and the second UV light pulse.

In one example, the laser 351 may emit a rectangular beam of approximately 3×6 mm, the first lens 353 and the second lens 354 may expand the beam, and the aperture 355 may allow a uniform portion of the laser beam to transmit through to the third lens 356 and correspondingly set the grating length. The third lens 356 may be a cylindrical lens with a focal length of 50 mm. To write a grating with half the reflectivity amplitude of an adjacent grating (achieving a ratio of 0.5), the aperture 355 and/or the third lens 356 may be positioned appropriately from the optical fiber 359 to collectively spread the beam and reduce the fluence by approximately half. The phase mask 357 and the mirror set 358 may operate as described for the third example optical component configuration 330 to provide wavelength tunability and phase control for the interference pattern directed onto the optical fiber 359.

FIG. 3E depicts a fifth example optical component configuration 370, similar to that shown in the fourth example optical component configuration 350 wherein the two mirror interferometer is replaced by a rectangular prism 378. The fifth example optical component configuration 370 includes a laser 371 that emits UV light, a mirror 372 that redirects the laser beam, a first lens 373 and a second lens 374 that together form an up-collimator, an aperture 375, a third lens 376, a phase mask 377, a prism 378, and an optical fiber 379. In this example, the laser light enters and exits through the front and rear surfaces of the prism 378 respectively, and is internally reflected by the sides of the prism 378.

The prism 378 in the fifth example optical component configuration 370 may replace the mirror set of the fourth example optical component configuration 350 while providing similar beam recombination functionality. The phase mask 377 may split the incoming UV beam into diffracted orders that enter the front surface of the prism 378, propagate through the prism 378, and undergo total internal reflection at the side surfaces of the prism 378 to redirect the beams toward the rear surface of the prism 378. The beams may exit through the rear surface of the prism 378 and recombine at the optical fiber 379 to create an interference pattern for inscribing gratings. The third lens 376 may be a cylindrical lens oriented to focus the beam out of the drawing plane, concentrating the laser energy onto the optical fiber 379, as described for the fourth example optical component configuration 350.

As an example, the laser 371 may emit light, the first lens 373 and the second lens 374 may expand the beam diameter, and the aperture 375 may transmit a uniform portion of the expanded beam. The third lens 376 may focus the beam to a line at the optical fiber 379, and the phase mask 377 may diffract the incoming beam into +1 and −1 orders that enter the prism 378. The prism 378 may be a fused silica rectangular prism with dimensions selected such that the diffracted beams undergo total internal reflection at the side surfaces and exit through the rear surface at angles that produce the desired interference pattern period at the optical fiber 379. Using the prism 378 may provide a more compact and mechanically stable arrangement compared to separate mirrors, as the reflecting surfaces are fixed relative to each other within the prism 378.

FIG. 3F depicts a sixth example optical component configuration 390 where the mirrors of the fourth example optical component configuration 350 are replaced with a phase mask at approximately half the period of the splitting mask. The sixth example optical component configuration 390 includes a laser 391 that emits UV light, a mirror 392 that redirects the laser beam, a first lens 393 and a second lens 394 that together form an up-collimator, an aperture 395, a third lens 396, a first phase mask 397, a second phase mask 398, and an optical fiber 399. The first phase mask 397 functions as a beam splitter, and the second phase mask 398 may be positioned at half the period of the first phase mask 397 to redirect the split beams toward the optical fiber 399.

In the sixth example optical component configuration 390, the first phase mask 397 may diffract the incoming UV beam into multiple orders. The second phase mask 398 may receive the diffracted beams from the first phase mask 397 and further diffract the beams to create an interference pattern directed onto the optical fiber 399. The period of the second phase mask 398 being half the period of the first phase mask 397 may result in the diffracted beams from the second phase mask 398 recombining at angles that produce the desired grating period at the optical fiber 399. The third lens 396 may be a cylindrical lens oriented to focus the beam out of the drawing plane, concentrating the laser energy onto the optical fiber 399.

In one example, the laser 391 may emit light at approximately 250 nm wavelength with a rectangular beam profile and the first lens 393 and the second lens 394 may expand the beam, after which the aperture 395 may transmit a uniform central portion of the expanded beam. The first phase mask 397 may have a period of 1070 nm, diffracting the beam into +1 and −1 orders. The second phase mask 398 may have a period of 535 nm (half the period of the first phase mask 397), further diffracting the beams to produce an interference pattern with a period of approximately 535 nm at the optical fiber 399. This interference pattern period may inscribe gratings with a Bragg wavelength of approximately 1550 nm in a fiber with an effective refractive index of 1.45. Thus, using the second phase mask 398 in place of mirrors may provide wavelength selectivity and reduce alignment sensitivity compared to some mirror-based interferometer configurations.

In the above examples shown in FIGS. 3A-3F, and in other examples, the UV beam that is not used in generating the desired grating structure may be redirected or blocked to prevent hitting the fiber. This is generally to reduce the likelihood of excess or stray UV light hitting the fiber that causes unintended enhanced photosensitivity in spots, or cause further changes in index of refraction in the fiber that effectively erase (or “cancel”) gratings already written partially or entirely. In some embodiments, mechanical guides may be added to the examples depicted in FIGS. 3A-3F to help align or constrain the fiber, to help ensure proper location and reduce fiber vibration during the grating writing process. Example guides may include posts with small slots cut around the circumference, and the fiber may ride along the slots during the grating inscription process.

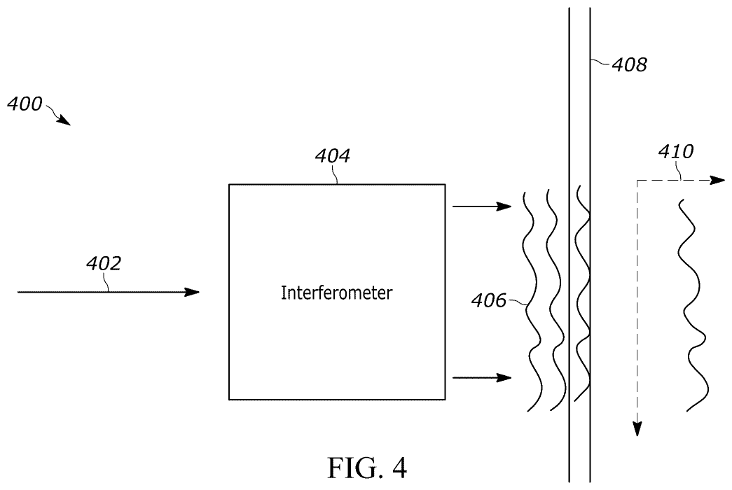

Using these various fibers and system configurations, the techniques described herein may be applied to inscribe gratings (e.g., overlapping gratings) into fibers. For example, FIG. 4 depicts an example grating writing process 400 showing how UV light is used to write gratings in an optical fiber 408. The example grating writing process 400 illustrates incident light 402 entering from the left side of the diagram, represented by a black arrow pointing toward an interferometer 404. The interferometer 404 receives the incident light 402 and generates an interference pattern. The incident light 402 may be UV light generated by a laser source (e.g., 132) and passes through the interferometer 404, which may be provided by a phase mask. The incident light 402 exits the interferometer 404 as a light field 406, illustrated by two blue arrows and wavy blue lines indicating the UV light field pattern created by the interferometer 404. The light field 406 is directed toward the optical fiber 408, shown as two parallel vertical lines positioned to the right of the interferometer 404. The light field 406 interacts with the optical fiber 408, causing controlled changes in the indices of refraction within the optical core of the optical fiber 408 to inscribe/write Bragg gratings.

An index of refraction change plot 410 is displayed on the right side of the diagram, shown as a wavy line with an arrow indicating the resulting grating pattern. The index of refraction change plot 410 represents the spatial variation in refractive index along the length of the optical fiber 408, where the vertical axis corresponds to the location along the fiber and the horizontal axis corresponds to the change in index of refraction at the locations shown. The example grating writing process 400 demonstrates how UV light generated by a laser source passes through the interferometer 404 to create the light field 406 that writes the grating pattern into the optical fiber 408 through selective exposure to alter the fiber's 408 local index of refraction. It should be appreciated that the pattern indicated by the plot 410 is the envelope of the interference pattern, and the fundamental sinusoidal interference pattern may be on the order of 500 nm.

The grating can be written by a single laser pulse of sufficient power. Using a single laser pulse approach, the systems described herein may continuously move the fiber 408 and a single laser pulse (e.g., 402) may be applied periodically as an appropriate amount of the fiber 408 has passed. Alternatively, the fiber 408 can be moved quasi-statically and be held stationary for the single laser pulse. Such a grating can be written by multiple pulses of the laser, instead of by a single laser pulse. In an example, the fiber 408 and laser and interferometer 404 are held stationary relative to each other, and multiple laser pulses are fired. Multiple laser pulses can be applied to increase the change in index of refraction, to reduce the power of each laser pulse applied as compared to the single laser pulse, or both.

In an example, to create a fiber Bragg grating, the light field 406 generated is a sinusoidal interference pattern where the period of the sinusoid is λ/2n, where λ is the wavelength of the reflected light, and n is the effective index of refraction of the fiber. The sinusoidal UV light field induces a refractive index modulation in the fiber core that exhibits a matching period (e.g., λ/2n). The reflectivity of the resulting grating has a non-linear relationship to this refractive index modulation. In certain embodiments, the reflectivity may be measured as a refractive index, and a ratio of reflectivity amplitudes between adjacent overlapping gratings may be not 0.5 to maintain reflectivity in overlap regions within acceptable bounds.

The gratings written using the example grating writing process 400 can be Type 1 gratings. For Type 1 gratings in a core of an optical fiber, the UV light induced index change is approximately proportional to the laser fluence. Type 1 gratings are generally written with moderate intensities below a certain threshold and exhibit an index grating across the core. Type 1 gratings are typically characterized by a linear increase in grating reflectivity with an increase in laser energy up to a threshold, beyond which, the process transitions into the regime of Type 2 grating formation through highly nonlinear changes to the UV light induced index modulation.

In certain embodiments, the control systems described herein (e.g., 142) may be configured to cause the positioning systems described herein (e.g., 134) to adjust the position of the optical fiber 408 or an optical component based on a spacing parameter to yield the overlap regions described herein (e.g., 173) between portions of the optical fiber 408. The spacing parameter may be less than or equal to a width of a beam profile of the UV light pulses, and the acceptable overlap or gap between gratings can be non-zero depending on the requirements of the intended use and application.

In one example implementation, the laser source may emit the incident light 402 at approximately 250 nm wavelength and the interferometer 404 may be a phase mask with a period of approximately 1070 nm, which creates the light field 406 as a sinusoidal interference pattern with a period of approximately 535 nm. This interference pattern period corresponds to a Bragg wavelength of approximately 1550 nm in the fiber 408 with an effective refractive index of 1.45. Accordingly, the control system 142 may cause the positioning system 134 to move the optical fiber 408 in discrete steps of approximately 10 mm (corresponding to the beam width along the fiber axis), with the laser source firing between each step while the optical fiber 408 is held stationary. The control system may alternate the laser energy between a nominal value (e.g., 15 mJ) and half the nominal value (e.g., 7.5 mJ) for successive pulses, with the spacing parameter set to approximately 8 mm to yield a 2 mm overlap region between adjacent gratings having a reflectivity ratio of approximately 0.5.

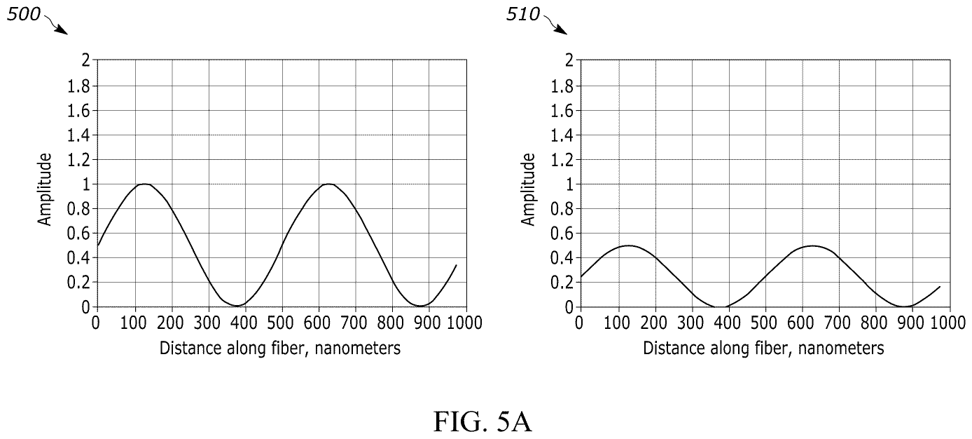

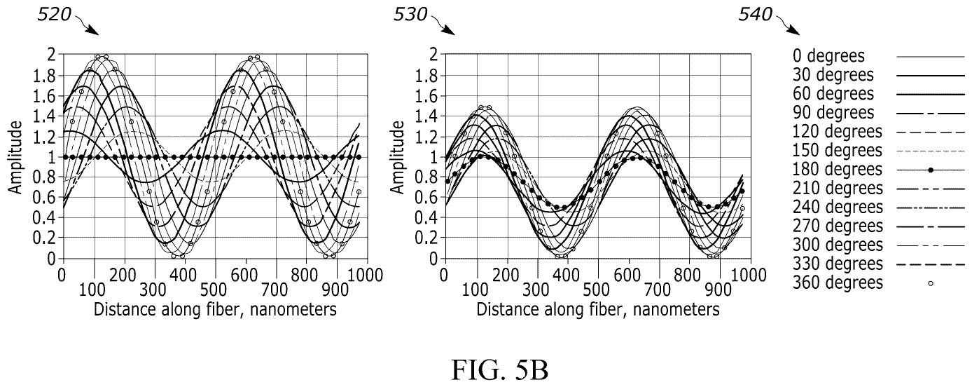

FIG. 5A depicts a first example refractive index modulation plot 500 and a second example refractive index modulation plot 510 showing refractive index modulation along an optical fiber for single gratings with different normalized index of refraction amplitudes. Where adjacent gratings are overlapped, and the light field used to generate the gratings are sinusoidal interference patterns, the behavior of two overlapping gratings can be modeled by the summation of two sinusoids. Two example sinusoids indicating refractive index modulation are shown in the plots 500 and 510 in FIG. 5A. In the example of FIG. 5A, the periods of the gratings are the same, the period of the sinusoids are the same, and the refractive index modulation of the second example refractive index modulation plot 510 is half of that of the first example refractive index modulation plot 500. In particular, these plots correspond to gratings of the same period, with the first example refractive index modulation plot 500 representing a grating having a reflectivity resulting in a refractive index modulation of 1.0 for the target wavelength for reflection (e.g., a central wavelength for reflection, a Bragg wavelength for a single frequency Bragg grating, etc.), and the second example refractive index modulation plot 510 representing a grating having a reflectivity resulting in a refractive index modulation of 0.5. In these examples, the refractive index modulation is normalized to a nominal value considered to be 1.0.

FIG. 5B depicts a first example effective refractive index modulation plot 520 and a second example effective refractive index modulation plot 530 showing the summation of two sinusoids with example phase differences from 0 to 360 degrees in 30 degree steps. The first example effective refractive index modulation plot 520 shows sums of two sinusoids matching the one shown in the first example refractive index modulation plot 500, at different phase differences as indicated in the legend 540. The second example effective refractive index modulation plot 530 sums one sinusoid matching the one shown in the first example refractive index modulation plot 500 with one sinusoid matching the one shown in the second example refractive index modulation plot 510, at different phase differences as indicated in the legend 540.

When the amplitudes are the same, if the phase between the two gratings is random, then the resulting refractive index modulation will be random with values between 2.0 and 0.0. Having an effective refractive index modulation of 0.0 corresponds to a region with no reflective signal, and is not desirable in cases where sensing in that region is desired. The two plots 520 and 530 also show that, when the amplitude ratio is 0.5 then the range of refractive index modulation is between 1.5 and 0.5. Where the precision of the manufacturing process is not sufficient to accurately place gratings (such as to much less than λ4n), the probability of gaps in reflectivity caused by overlapping gratings can be substantial enough to negatively affect manufacturing yield. Example values of interest in certain types of high-resolution sensing include λ/4n being approximately 200 nm to 300 nm, such as around 200 nm, 225 nm, 250 nm, 275 nm, or 300 nm.

The techniques described herein can provide a grating writing process that reduces or eliminates the likelihood of resulting grating reflectivity falling too low. In particular, these techniques ensure that the grating reflectivity will not fall below half of the nominal grating reflectivity by alternating the writing laser energy between the nominal value and half the nominal value, a ratio of 0.5. Other ratios of values for the two laser energies can be used, with differing effects on the resulting potential reflectivity mean and variation. In some examples, the ratio of 0.5 can help maximize the minimum reflectivity over an entire array of gratings where other variations are random, and help maximize the minimum SNR.

As an example, a grating writing system may write a first grating in an optical fiber to produce a refractive index modulation with a normalized amplitude of 1.0 and a second grating adjacent to and at least partially overlapping the first grating to produce a refractive index modulation with a normalized amplitude of 0.5. If the phase difference between the two gratings in the overlap region is 90 degrees, the resulting effective refractive index modulation may be approximately 1.12, given by the square root of the sum of the squares of the two amplitudes: \sqrt{1.0²+0.5²}≈1.12. However, if the phase difference is anywhere else between 0 and 180 degrees, the resulting effective refractive index modulation may be between approximately 1.5 and 0.5, respectively. Thus, in all cases, the resulting effective refractive index modulation remains above 0.0, ensuring that the overlap region maintains sufficient reflectivity for sensing applications.

In certain embodiments, the ratio may be between 0.4 and 0.6, such as 0.5. For example, a grating writing system may be configured such that the control system causes the laser source to emit a first UV light pulse at an energy of 10 mJ to write a first grating with a reflectivity amplitude of 1.0, and causes the laser source to emit a second UV light pulse at an energy of 5 mJ to write a second grating with a reflectivity amplitude of 0.5, achieving a ratio of 0.5. In another example, a grating writing system may be configured such that the control system causes the laser source to emit a first UV light pulse at an energy of 14 mJ to write a first grating with a reflectivity amplitude of 1.0, and causes the laser source to emit a second UV light pulse at an energy of 6.3 mJ to write a second grating with a reflectivity amplitude of 0.45, achieving a ratio of 0.45.

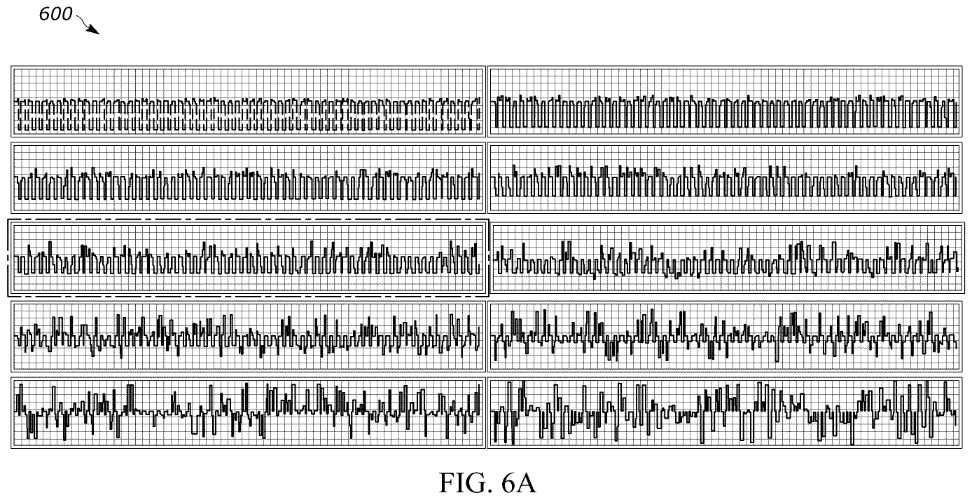

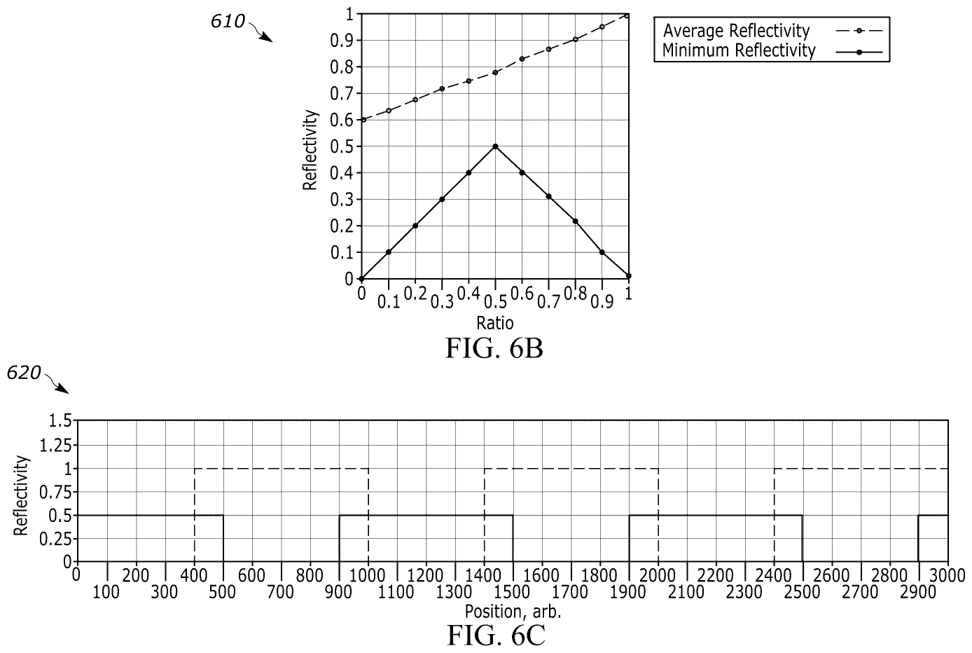

FIG. 6A depicts example fiber sensor simulations 600 showing reflectivity profiles for simulated fiber sensor arrays with grating arrays having different grating reflectivity ratios. The graphs representing these simulations illustrate resulting reflectivities for different ratios of the laser powers applied for adjacent gratings. A complete sensor array for a range of grating reflectivity ratios is simulated. In this particular example, these simulated arrays have 10 mm gratings, 2 mm overlap regions, a total of 130 gratings, and covers a fiber length of about 1.2 meters. The result from a ratio of 0.5 is the third one down on the left column, and highlighted with a dotted line border. For convenience, the ratios shown are with the lower power in the numerator, and one skilled in the art will appreciate that putting the lower power in the denominator would change the ratio from 0.1 to 1.0 to their respective reciprocals, and range from 10.0 to 1.0. It should also be appreciated that the simulations 600 may also represent randomly set phases between the adjacent gratings.

The example fiber sensor simulations 600 represent ten separate simulation results. The top left simulation displays a simulation for a ratio of 0.1, the top right simulation displays a simulation for a ratio of 0.2, and this incremental increase from 0.1 to 1.0 continues until the bottom right simulation, which displays a simulation for the ratio of 1.0. The waveform patterns vary across the different ratio values, with lower ratios showing consistently lower amplitudes and higher ratios showing increased amplitude variability.

In certain embodiments, the grating writing systems described herein may write gratings with three, four, or more sets of gratings with different reflectivities instead of two sets. For example, a grating writing system may be configured to write a first set of gratings at a nominal reflectivity amplitude of 1.0, a second set of gratings at a reflectivity amplitude of 0.67, and a third set of gratings at a reflectivity amplitude of 0.33. The control systems described herein (e.g., 142) may cause the laser sources described herein (e.g., 132) to cycle through three different energy values corresponding to these reflectivity amplitudes, with the positioning systems described herein (e.g., 134) coordinating the fiber movement to create overlap regions between adjacent gratings from different sets. Various combinations of these gratings may result in reflectivity profiles similar to one of the simulations depicted in the example fiber sensor simulations 600.

FIG. 6B depicts an example reflectivities plot 610 showing average and minimum reflectivity as a function of ratio for the simulated fiber sensor arrays. The plots 610 show the calculated average reflectivity and the minimum reflectivity for each graph shown in FIG. 6A. A reflectivity ratio of 0.5 results in the maximum potential minimum reflectivity, and may be preferred where the criteria for choosing a ratio is to maximize this potential minimum reflectivity. The plots 610 also show there is a range of ratios that would also provide sufficient reflectivity for various sensing applications. For example, for some applications, ratios that are other than 0.5, may be sufficient. Other applications may tolerate wider ratios (such as 0.1 to 0.9 or 0.2 to 0.8) while other applications may benefit from narrower ratios (such as 0.3 to 0.7, 0.4 to 0.6, 0.45 to 0.55, etc.). Some applications may prefer ranges not symmetric about 0.5, such as where factors other than minimum reflectivity, system design, manufacturing tolerances, and the like have substantial effect. The workable range in practice depends on factors such as the acceptable SNR for the intended application.

The example reflectivities plot 610 includes two traces. The top trace represents the average reflectivity and increases linearly from approximately 0.5 at a ratio of 0 to approximately 1.0 at a ratio of 1. The bottom trace represents minimum reflectivity values and increases from 0 at a ratio of 0 to a peak of approximately 0.5 at a ratio of 0.5, then decreases back to 0 at a ratio of 1. Accordingly, a reflectivity ratio of 0.5 results in the maximum potential minimum reflectivity across the grating array.

As an example, a fiber sensor application requiring a minimum SNR corresponding to a minimum reflectivity of 0.3 may use grating reflectivity ratios in the range of approximately 0.25 to 0.75, as indicated by the bottom trace in the example reflectivities plot 610. A more demanding application requiring a minimum reflectivity of 0.4 may use grating reflectivity ratios in the narrower range of approximately 0.35 to 0.65. The control systems described herein (e.g., 142) may be configured to select the appropriate ratio based on the requirements of the intended sensing application.

Assuming ideal operating conditions with true randomness in manufacture, etc., the condition that optimizes SNR where two gratings overlap is that the ratio of their reflectivities be as close to 0.5 as possible. FIG. 6C depicts an example ratio plot 620 providing a graphical representation of this condition that can be used to help assess the performance of grating “shape” (e.g., index of refraction amplitude). The example ratio plot 620 is a plot of a portion of the array showing alternating gratings along the length of a fiber sensor (“position, arb”). The overlapping portions of the two traces indicates the ratio of the two grating reflectivities. Thus, each section of the traces at 1.0 reflectivity indicates a grating written with 1.0 index of refraction amplitude, and each section of the traces at 0.5 reflectivity indicates a grating written with 0.5 index of refraction amplitude. In the regions where the traces overlap, the ratio is 0.5.

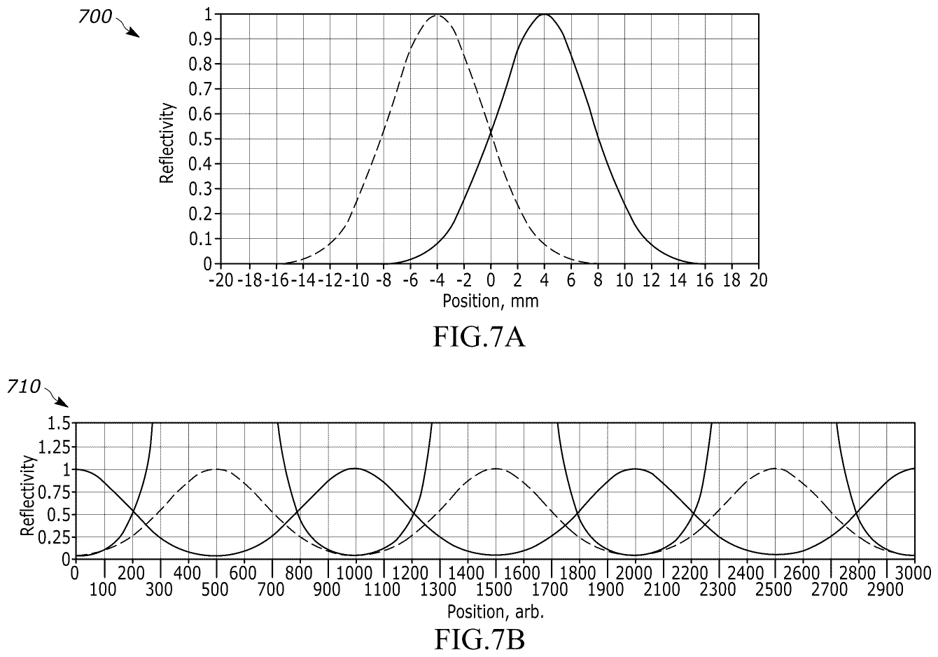

Much of the analysis above assumes the laser beam writing the grating profile is uniform across the region in which the laser beam impacts the core. However, some laser beams have non-uniform profiles, such as a Gaussian-like profile. FIG. 7A depicts an example two grating reflectivity plot 700 showing an example Gaussian-like profile, with laser power at a central portion of the beam being higher than laser power in a peripheral portion of the beam, and nonlinear variation across the beam. A laser with a Gaussian-like profile, if not further changed, generally produces a grating with a reflectivity having a Gaussian-like profile. To achieve a more uniform beam, and facilitate more uniform reflectivity across one grating, the laser beam diameter can be limited by an aperture that passes only a portion of the laser beam, such as around the peak. In some instances, the laser beam diameter is first increased appropriately with a beam expander and then an aperture used to pass only a region around the peak where the beam profile is more uniform. This approach helps to maintain the grating length and avoid the reduction in potential grating length that can be written by a laser pulse if an aperture is applied without beam expansion. As noted above, alternatively, the beam diameter could be left unchanged, a smaller aperture could be used, to produce shorter gratings from a laser pulse than if the diameter is not apertured. The shorter gratings can be placed closer together.

Referring to FIG. 4, an aperture can be incorporated into the interferometer 404, such as being integrated with a component containing a phase mask of the interferometer 404. An aperture can also be placed between the interferometer 404 and the fiber containing the core(s) in which the gratings are to be written. The example two grating reflectivity plot 700 shows the theoretical resulting reflectivity where two gratings with Gaussian-like beam shaped reflectivities are written near each other, when no aperture is used to trim a laser beam with a Gaussian-like profile.

Specifically, the example two grating reflectivity plot 700 has a horizontal axis representing position in mm ranging from approximately −20 to 20, and a vertical axis representing reflectivity ranging from 0 to 1. The left trace of the plot 700 is centered at approximately −4 mm and the right trace of the plot 700 is centered at approximately 4 mm. In the overlap region between the two traces, the reflectivity contributions from both corresponding gratings combine according to the phase relationship between the gratings, as described above with reference to FIGS. 5A and 5B.

As an example, a grating writing system may emit a light pulse with a Gaussian-like beam profile having a full width at half maximum (FWHM) of 8 mm to write a first grating centered at position −4 mm along the optical fiber, and may emit a second light pulse with the same Gaussian-like beam profile to write a second grating centered at position 4 mm along the optical fiber. The overlap region between the two gratings extends from approximately −4 mm to approximately 4 mm. In this overlap region, the reflectivity of the first grating follows the falling edge of the Gaussian-like profile (decreasing from approximately 0.5 to approximately 0.1), while the reflectivity of the second grating follows the rising edge of the Gaussian-like profile (increasing from approximately 0.1 to approximately 0.5). The ratio of these reflectivities varies continuously across the overlap region rather than remaining at a constant value of 0.5.

FIG. 7B depicts an example reflectivity ratio plot 710 showing an example ratio plot with idealized gratings having reflectivities having a Gaussian-like shape (a “Gaussian-like shaped grating”) arranged in an array. In this example, there is no spacing, or amplitude ratio, which would produce the condition where the overlap region is free from reflectivities which would reach zero or close to zero. Compare the reflectivity ratio shown in the example reflectivity ratio plot 710 with the earlier example where the reflectivity ratio is near 0.5 anywhere the beams overlap, as shown in the example ratio plot 620.

Specifically, the example reflectivity ratio plot 710 displays reflectivity on the vertical axis ranging from 0 to approximately 1.5 and position in arbitrary units on the horizontal axis ranging from 0 to 3000. The example reflectivity ratio plot 710 shows alternating gratings along the length of a fiber sensor, where adjacent gratings are written with a normalized index of refraction amplitude of approximately 1.0. The trace extending outside the plot 710 indicates the ratio of the two grating reflectivities, showing periodic variations that correspond to the overlap regions between adjacent gratings. The example reflectivity ratio plot 710 thus illustrates how Gaussian-like shaped gratings without aperturing can result in ratio values that deviate from the optimal value of 0.5 in the overlap regions.

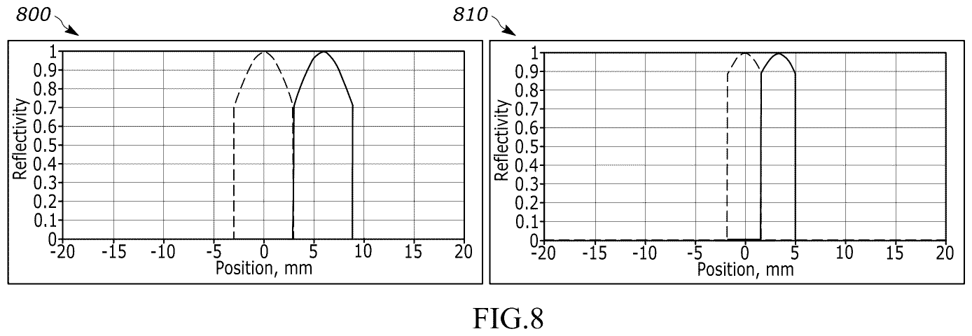

FIG. 8 depicts a first example apertured reflectivity plot 800 and a second example apertured reflectivity plot 810 showing how apertured laser beams can be used to write shorter gratings that can be placed with precision to reduce or avoid gaps. In particular, FIG. 8 illustrates an example where an aperture is used to block a portion of the laser beam at a defined distance away from the peak. Such an apertured laser beam can be used to write shorter gratings, and these shorter gratings can be placed with precision to reduce or avoid gaps. The degree of “windowing” of the laser beam (also called “apodization”) can be selected to achieve the desired uniformity, at the expense of reducing the length of individual gratings (and thus more gratings are written, and more writing cycles are involved, to complete a given array length). For the two cases represented in the plots 800 and 810, the uniformities obtained by aperturing are about 70% (plot 800) and 90% (plot 810). Note that the gratings are shorter for the greater uniformity, and the gratings are placed closer together. As noted earlier, in some instances, the light spreading components (e.g., 150) and/or beam expanders described herein (e.g., 161) can be used to spread out the laser beam and decrease the reduction in grating length.

This arrangement illustrated by FIG. 8 is more similar to the uniform grating arrangement discussed earlier than the arrangement of FIGS. 7A and 7B. In the example of FIG. 8, lower precision placement of the gratings can be mitigated by alternating the grating strength, such as with a 0.5 ratio or another ratio. The degree to which a laser beam would be apertured depends on the actual beam shapes, the degree of uniformity desired, the SNR acceptable for the application, etc. In many cases, a Gaussian-like laser beam profile that falls to zero is undesirable, as the zero-region of the laser beam profile produces no gratings and no reflectivity. For many real-world applications with laser beams, an aperture is used to achieve adequate uniformity for the application.

Both plots 800 and 810 display reflectivity on the vertical axis ranging from 0 to 1 and position in mm on the horizontal axis ranging from approximately −20 mm to 20 mm. The first example apertured reflectivity plot 800 shows two overlapping grating profiles, with a first trace representing a grating with a reflectivity profile reaching a peak of approximately 1.0 centered around 0 mm, and a second trace representing another grating with a reflectivity profile reaching a peak of approximately 1.0 centered around 6 mm. The second example apertured reflectivity plot 810 shows two overlapping grating profiles with a first trace representing a grating with a reflectivity profile reaching a peak of approximately 1.0 centered around 0 mm, and a second trace representing another grating with a reflectivity profile reaching a peak of approximately 1.0 centered around 4 mm.

For example, a grating writing system may emit a light pulse with a Gaussian-like beam profile having a FWHM of 12 mm. The aperture component may be configured to pass a central 6 mm portion of the beam where the intensity variation is within 30% of the peak value. This arrangement may correspondingly achieve approximately 70% uniformity, as shown in the first example apertured reflectivity plot 800. The resulting grating may have a length of approximately 6 mm rather than the 12 mm that would result without aperturing. To write a 1.2 meter sensor array with 6 mm gratings and 1 mm overlap regions, the control system may cause the positioning system to position the optical fiber for approximately 240 laser pulses, compared to approximately 130 pulses that would be used with 10 mm gratings.

In another example, a grating writing system may use a beam expander to expand the laser beam diameter from 6 mm to 18 mm before the aperture component passes a central 4 mm portion where the intensity variation is within 10% of the peak value. Such an arrangement may achieve approximately 90% uniformity, as shown in the second example apertured reflectivity plot 810. The resulting grating may have a length of approximately 4 mm and may maintain high uniformity while utilizing the expanded beam profile.

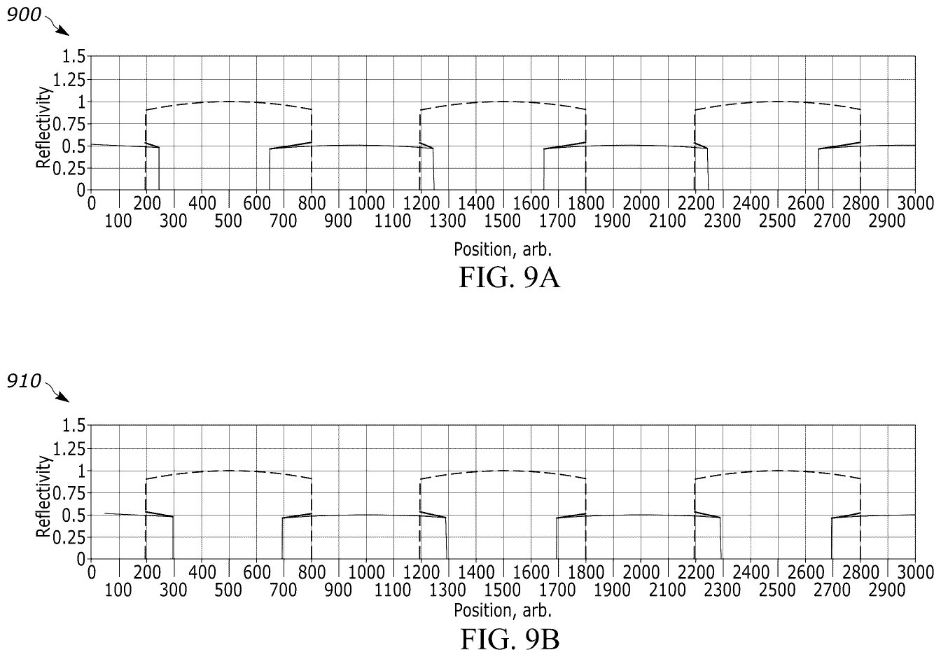

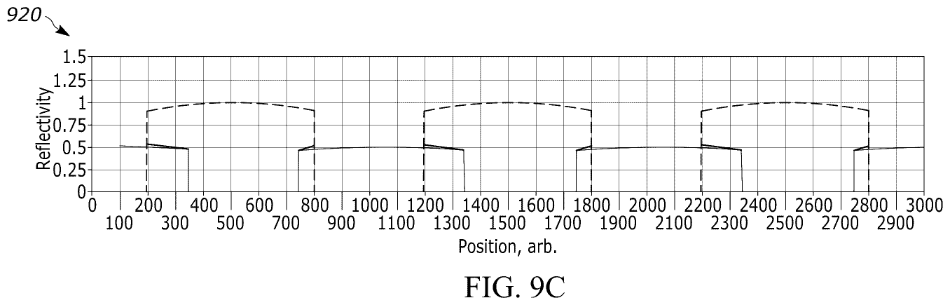

FIGS. 9A-9C depict ratio plots illustrating idealized Gaussian-like shaped gratings written by laser beams with Gaussian-like profiles that have been apertured to the 90% uniformity level, and how such Gaussian-like shaped gratings can be overlapped with low precision and still achieve ratio values close to 0.5. FIG. 9A depicts a first example apertured ratio plot 900 showing alternating gratings along the length of a fiber sensor with a first spacing configuration. The first example apertured ratio plot 900 displays reflectivity on the vertical axis ranging from 0 to approximately 1.5 and position in arbitrary units on the horizontal axis ranging from 0 to 3000. The first example apertured ratio plot 900 includes sections indicating gratings written with a nominal index of refraction amplitude of approximately 1.0 and sections indicating gratings written with approximately half the nominal index of refraction amplitude at 0.5. A trace in the first example apertured ratio plot 900 represents the ratio of the two grating reflectivities in the overlap regions, showing values close to 0.5 where adjacent gratings of different amplitudes intersect.

FIG. 9B depicts a second example apertured ratio plot 910 with the same axis configuration as the first example apertured ratio plot 900, displaying a slightly different spacing configuration between adjacent gratings while maintaining the alternating pattern of grating sections with the ratio trace in the overlap regions. FIG. 9C depicts a third example apertured ratio plot 920, also with the same axis configuration, illustrating a third spacing configuration indicating the tolerance for low precision grating placement while still achieving ratio values close to 0.5 in the overlap regions between adjacent gratings. The three plots 900, 910, and 920 collectively indicate apertured Gaussian-like shaped gratings can achieve desired reflectivity ratios across various placement tolerances, with each plot showing complete sets of overlapping grating pairs where the ratio trace remains stable near 0.5 in the overlap regions.

As an example, a grating writing system may use an aperture component to achieve 90% uniformity from a Gaussian-like beam profile, producing gratings with lengths of approximately 4 mm. The grating writing system may position the optical fiber with a spacing parameter of 3.5 mm between successive laser pulses, yielding a 0.5 mm overlap region. In another example, the spacing parameter may be 3.2 mm, yielding a 0.8 mm overlap region. In a further example, the spacing parameter may be 3.8 mm, yielding a 0.2 mm overlap region. In each of these configurations, the ratio of reflectivity amplitudes in the overlap regions remains close to 0.5 because, e.g., the control system may alternate the laser energy between a nominal value and half the nominal value for successive pulses.

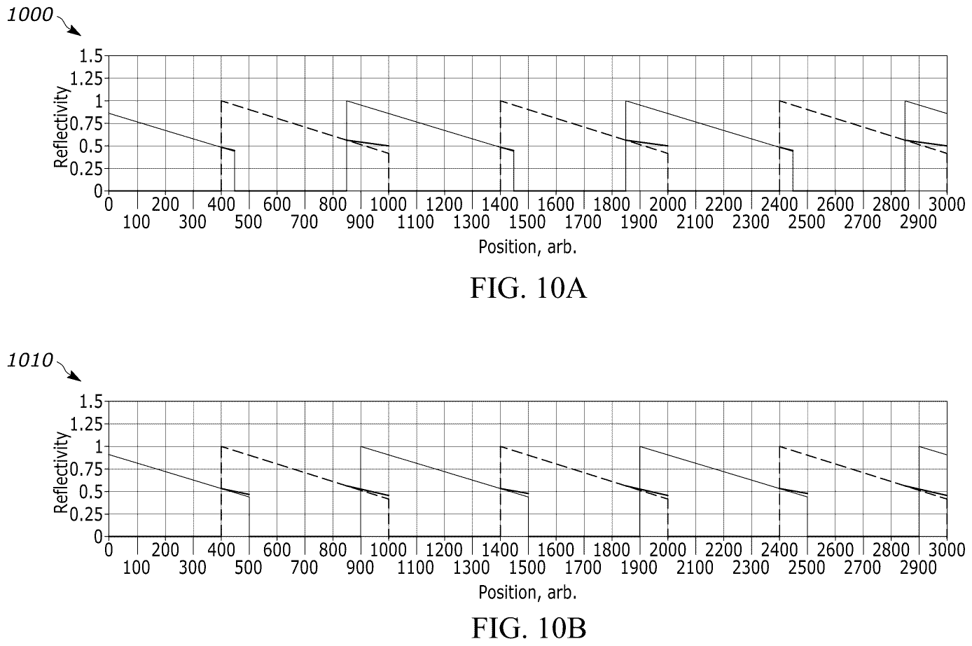

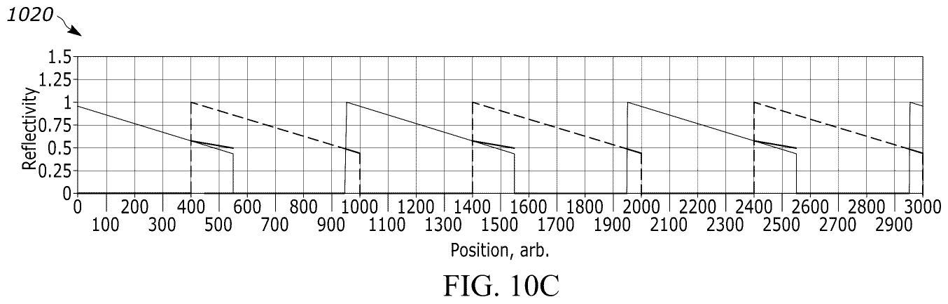

FIGS. 10A-10C depict ratio plots illustrating example configurations of gratings with ramped reflectivity shapes arranged in arrays along an optical fiber at different overlap spacings. In some instances of such a grating inscription approach, the overlapped regions are still designed to achieve close to the 0.5 ratio, although other instances target some other ratio or range of ratios. The example ratio plots 1000-1020 each represent an example scenario with first and second sets of gratings, where the two sets of gratings each have gratings with similar shapes and reflectivities. In particular, each grating shown in the plots 1000-1020 includes a reflectivity profile having an “offset ramp” shape, and equal grating reflectivities. In this example scenario, the laser energy is not changed between gratings. The controlled variation in reflectivity along the length of the grating helps to ensure adjacent gratings do not overlap where their reflectivities are equal. The spacing between gratings is varied among the three plots 1000-1020 to show the tolerance for low precision grating placement. Note that, to help illustrate the effect, the ratio in the overlap region shown in the overlap region of the two traces is close to 0.5 with a slight slope.

Each of the example ramped reflectivity plots 1000, 1010, and 1020 depicted in FIGS. 10A, 10B, and 10C, respectively, show alternating gratings in two traces along a horizontal axis representing position in arbitrary units ranging from 0 to 3000 and a vertical axis representing reflectivity ranging from 0 to approximately 1.5. Each plot 1000-1020 has two traces representing gratings written with a nominal index of refraction amplitude and having ramped reflectivity profiles. For example, the first example ramped reflectivity plot 1000 represents a grating writing process where the first grating (represented by the first trace from the left side of the plot 1000) has a relatively minimal overlap region with the beginning of the second grating (represented by the second trace from the left side of the plot 1000) and the second grating has a relatively substantial overlap region with the beginning of a third grating. The second example ramped reflectivity plot 1010 represents a grating writing process where the first grating has an overlap region with the beginning of the second grating that is roughly equivalent with the overlap region the second grating has with the beginning of a third grating. The third example ramped reflectivity plot 1020 represents a grating writing process where the first grating has a relatively substantial overlap region with the beginning of the second grating and the second grating has a relatively minimal overlap region with the beginning of a third grating. These overlap regions may iteratively repeat during the respective grating writing processes illustrated in FIGS. 10A-10C, as the control systems described herein may maintain consistent spacing between laser pulses as the grating writing continues.

As an example, a grating writing system may write gratings with offset ramp shaped reflectivity profiles using a spacing parameter of 7 mm between successive laser pulses for 10 mm gratings, yielding a 3 mm overlap region. A neutral density filter with a linear transmission gradient from 100% to 50% may produce gratings where the reflectivity decreases from approximately 1.0 at the first end to approximately 0.5 at the second end. In the overlap region, the falling edge of one grating (decreasing from approximately 0.55 to approximately 0.45) overlaps with the falling edge of the adjacent grating (decreasing from approximately 1.0 to approximately 0.90), maintaining a ratio close to 0.5 throughout the overlap region.

In certain embodiments, the grating writing systems described herein (e.g., 130) may be configured to cause the first ultraviolet light pulse to have a non-uniform spatial energy profile to produce a grating having a non-uniform reflectivity profile. The non-uniform spatial energy profile may have at least one characteristic selected from the group consisting of: strict monotonicity; linearity; similarity to a truncated portion of a Gaussian-like profile; having a ramped shape; variation by less than 30% across the profile; and/or a minimum energy 70% in a range where no energy is 0% and a highest energy in the profile is 100%.

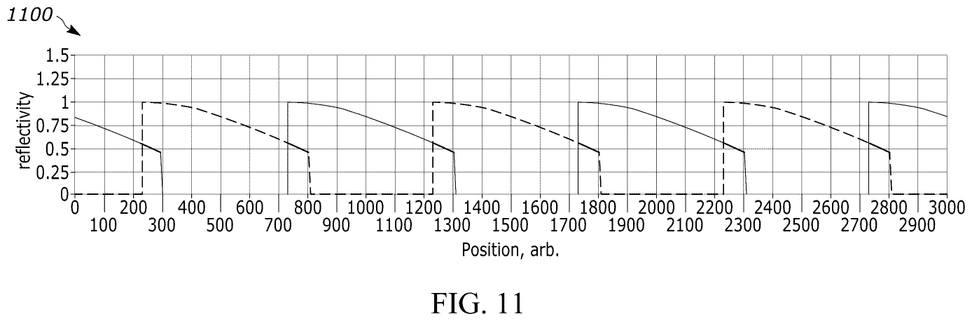

A variety of different techniques can be used to provide a non-uniform laser beam to write gratings with “ramped” type reflectivity profiles. For example, a laser beam with a Gaussian-like shape can be apertured to allow laser beam passage on one side of the peak, instead of on both sides of the peak. FIG. 11 depicts an example offset aperture reflectivity plot 1100 showing the ratio plot for example gratings that could be created by an example Gaussian-like laser beam, where the aperture component has been offset to one side to provide a shape similar to the offset ramp discussed above.

The example offset aperture reflectivity plot 1100 displays reflectivity on the vertical axis ranging from 0 to approximately 1.5 and position in arbitrary units on the horizontal axis ranging from 0 to 3000. The example offset aperture reflectivity plot 1100 shows a repeating pattern of gratings along the length of a fiber sensor, with traces representing gratings exhibiting a reflectivity profile having an offset ramp shape, and where the reflectivity gradually decreases along the fiber length. The overlap regions in the example offset aperture reflectivity plot 1100 show that the ratio of the two grating reflectivities between adjacent gratings remains close to 0.5 throughout the length of the overlap regions, despite the slight slope of the corresponding grating reflectivities.

In certain embodiments, the grating writing systems described herein may be configured to cause a first ultraviolet light pulse to have a sloped spatial energy profile, such that the first ultraviolet light pulse writes a grating having a sloped spatial refractive index power profile. The grating writing system may further comprise an aperture component configured to modify a beam profile of the ultraviolet light pulses emitted by a laser source, and the aperture component may be offset relative to a peak of the beam profile. The grating writing system creates a slope in the grating reflectivity along the length of the resulting grating by offsetting the aperture component to allow passage of a portion of a Gaussian-like laser beam to one side of the peak. The grating writing system thus produces adjacent gratings with equal amplitudes to achieve approximately 0.5 ratio in the overlap regions.

As an example, a grating writing system may use a laser source emitting a beam with a Gaussian-like profile having a FWHM of 14 mm. The aperture component may be offset by 3 mm from the beam center to pass a 5 mm portion of the beam extending from the peak toward one edge, blocking the opposite side of the beam profile. The resulting grating may have a reflectivity profile that decreases from approximately 1.0 at the end corresponding to the beam peak to approximately 0.5 at the end corresponding to the peripheral portion of the beam. When adjacent gratings are positioned such that the high-reflectivity end of one grating overlaps with the low-reflectivity end of the adjacent grating, the ratio of reflectivity amplitudes in the overlap region may remain close to 0.5 without requiring alternation of laser energy between successive pulses.

Another example technique to produce a “ramped” profile uses the neutral density filter with a linear transmission gradient from 100% to 50%. Such a filter, when placed between an interferometer (e.g., 404) and the optical fiber, may help define the resulting laser beam energy that reaches the cores to be written, and result in a “ramped” grating reflectivity profile. Many techniques can be used to provide a grating reflectivity shape that is “ramped,” including those similar to the idealized examples shown in FIGS. 10A-10C and FIG. 11, and are within the scope of what is contemplated herein.

Moreover, many variations of the described examples exist, and are contemplated. For example, although the example ratio used is often 0.5, other ratios are contemplated. Also, although the examples set forth usually describe two sets of gratings (such as a first set at nominal reflectivities and a second at other than nominal reflectivities), other instances may have three, four, or more sets of gratings with different reflectivities. Further, although particular example non-uniform laser beam profiles and grating reflectivity profiles are shown, other laser beam and grating reflectivities are contemplated.

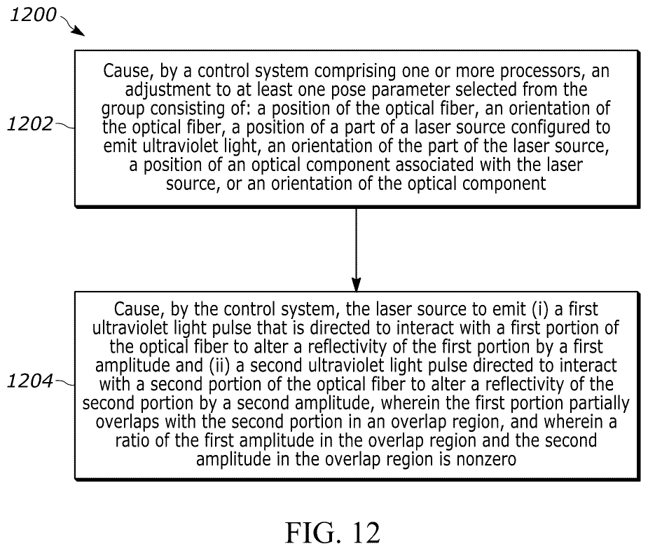

FIG. 12 depicts an example method 1200 for writing overlapping gratings in an optical fiber. The example method 1200 may be performed by the grating writing systems described herein (e.g., 100, 130) and provides an approach for inscribing fiber Bragg gratings with controlled reflectivity ratios in overlap regions. The example method 1200 addresses technical challenges associated with precise grating placement by controlling the ratio of reflectivity amplitudes between adjacent overlapping gratings to maintain overlap region reflectivity within acceptable bounds and thereby improve manufacturing yield and sensor performance.

The example method 1200 comprises causing, by a control system (e.g., 142) comprising one or more processors (e.g., 167), an adjustment to at least one pose parameter selected from the group consisting of: a position of the optical fiber, an orientation of the optical fiber, a position of a part of a laser source (e.g., 132) configured to emit ultraviolet light, an orientation of the part of the laser source, a position of an optical component associated with the laser source, or an orientation of the optical component (block 1202). At block 1202, the control system may coordinate a positioning system (e.g., 134) to move the optical fiber relative to the laser source and associated optical components to position a target portion of the optical fiber in front of an interferometer or phase mask for grating inscription. For example, the control system may cause a linear stage to move the optical fiber along a track while coordinating with a reel to maintain proper tension and positioning a first portion of the optical fiber at a location where a first light pulse will inscribe a first grating. The grating writing system may thereby position specific sections of the optical fiber for grating inscription while maintaining the spatial relationships between adjacent gratings that yield controlled overlap regions with nonzero reflectivity ratios. The systems described herein may thereby reduce the likelihood of regions within optical fibers having unacceptably low reflectivity.

The example method 1200 further comprises causing, by the control system, the laser source to emit (i) a first ultraviolet light pulse that is directed to interact with a first portion of the optical fiber to alter a reflectivity of the first portion by a first amplitude and (ii) a second ultraviolet light pulse directed to interact with a second portion of the optical fiber to alter a reflectivity of the second portion by a second amplitude (block 1204). The first portion partially overlaps with the second portion in an overlap region, and a ratio of the first amplitude in the overlap region and the second amplitude in the overlap region is nonzero.

The control system may trigger the laser source to emit ultraviolet light pulses at controlled energy values to write gratings with different reflectivity amplitudes in adjacent portions of the optical fiber. For example, the control system may cause the laser source to emit a first ultraviolet light pulse at 15 mJ to write a first grating with a reflectivity amplitude of 1.0 in the first portion, and subsequently cause the laser source to emit a second ultraviolet light pulse at 7.5 mJ to write a second grating with a reflectivity amplitude of 0.5 in the second portion. The first portion and the second portion may overlap by approximately 2 mm or any suitable value. The range of resulting refractive index modulation in the overlap region may then be between 1.5 and 0.5 times the nominal value, rather than between 2.0 and 0.0 as occurs with equal amplitude gratings. As a result, the reflectivity in the overlap region remains within acceptable bounds even when the gratings overlap with random phase relationships.

In certain embodiments, the method 1200 further comprises causing, by the control system, the laser source to emit the first ultraviolet light pulse and the second ultraviolet light pulse during a single writing pass along the optical fiber. In these embodiments, the control system may alternate the laser energy between successive pulses as the optical fiber moves continuously or in discrete steps past the interferometer to produce fully inscribed optical fiber sensors without requiring multiple passes along the fiber length.

In certain embodiments, the method 1200 further comprises causing, by the control system, the laser source to emit the first ultraviolet light pulse during a first writing pass along the optical fiber; and causing, by the control system, the laser source to emit the second ultraviolet light pulse during a second writing pass along the optical fiber, the second writing pass occurring before an initiation of the first writing pass or after a completion of the first writing pass. As an example, the control system may set the laser energy to a nominal level during the first writing pass to inscribe gratings at positions 0 mm, 8 mm, 16 mm, and so forth along the fiber length. The control system may then cause the positioning system to return the optical fiber to the starting position and perform the second writing pass with the laser energy set to half the nominal level to inscribe gratings at positions 4 mm, 12 mm, 20 mm, and so forth, creating overlap regions between adjacent gratings from the first and second passes with a reflectivity ratio of 0.5.

In certain embodiments, the reflectivity may be measured as a refractive index, and the ratio may be not 1.0. A ratio that is not 1.0 indicates that the first amplitude and the second amplitude in the overlap region differ from each other, which may help maintain reflectivity within acceptable bounds regardless of the phase relationship between the overlapping gratings. When the ratio is 1.0, the resulting refractive index modulation in the overlap region may range from 2.0 to 0.0 depending on the phase difference, potentially resulting in regions with no reflective signal.

In certain embodiments, the ratio may be between 0.4 and 0.6. This range of ratios may provide a balance between maintaining sufficient minimum reflectivity in overlap regions and achieving acceptable average reflectivity across the grating array. For example, a ratio of 0.4 may result in a minimum refractive index modulation of approximately 0.4 times the nominal value in the overlap region, while a ratio of 0.6 may result in a minimum refractive index modulation of approximately 0.4 times the nominal value. The control system may be configured to achieve ratios within this range by controlling the laser energy values for successive pulses or by using energy changing components to modify the beam energy.

In certain embodiments, the ratio may be 0.5. A ratio of 0.5 may maximize the minimum reflectivity over an entire array of gratings where other variations are random and may help maximize the minimum SNR. The control system may achieve a ratio of 0.5 by alternating the writing laser energy between the nominal value and half the nominal value for successive pulses.

In certain embodiments, the control system may be configured to provide the first ultraviolet light pulse at a first energy value and the second ultraviolet light pulse at a second energy value that is different from the first energy value. To provide the first ultraviolet light pulse at the first energy value and the second ultraviolet light pulse at the second energy value, the control system may be configured to control an output energy of the laser source. Additionally, or alternatively, the control system may be configured to temporally coordinate the laser source providing ultraviolet light with activation or actuation of an energy changing component of the grating writing system. The energy changing component may modify the energy of the ultraviolet light pulses to achieve the different energy values between successive pulses.

In certain embodiments, the energy changing component may comprise a light attenuating component, a light blocking component, a light spreading component, or a light augmenting component. The light attenuating component may reduce the intensity of the ultraviolet light pulses, the light blocking component may selectively block portions of the beam profile, the light spreading component may spread the ultraviolet light over a larger area to reduce fluence at the optical fiber, and the light augmenting component may increase the fluence of the ultraviolet light at the optical fiber. To temporally coordinate the laser source providing ultraviolet light with the activation or actuation of the energy changing component, the control system may be configured to synchronously trigger the laser source and a change in the activation or actuation of the energy changing component.

In certain embodiments, the grating writing system may further comprise an attenuator, and to provide the first ultraviolet light pulse at a first energy value and the second ultraviolet light pulse at a second energy value, the control system may be configured to temporally coordinate the laser source emitting the first and second ultraviolet light pulses with an attenuation of the attenuator. The attenuator may be a solid-state attenuator capable of changing states rapidly to alternate between different levels of attenuation for successive pulses.

In certain embodiments, the grating writing system may further comprise a filter wheel, and to provide the first ultraviolet light pulse at the first energy value and the second ultraviolet light pulse at the second energy value, the control system may be configured to temporally coordinate the laser source providing ultraviolet light with a rotation of the filter wheel to selectively position one or more filters of the filter wheel in an optical path of the ultraviolet light. The filter wheel may be configured with sets of transmission filters with differing transmission ratios, and the filter wheel may be rotated with the laser firings such that adjacent gratings are written with different laser power.

In certain embodiments, the grating writing system may further comprise a filter mounting mechanism configured to attach one or more filters to a damped resonant structure. The system may provide the first ultraviolet light pulse at the first energy value and the second ultraviolet light pulse at the second energy value by temporally coordinating the laser source providing ultraviolet light with a position adjustment to the damped resonant structure to selectively position the one or more filters in an optical path of the ultraviolet light.

In certain embodiments, the control system may be configured to cause the laser source to provide a sequence of ultraviolet light pulses alternating between first and second energy values. The sequence of ultraviolet light pulses may comprise the first ultraviolet light pulse and the second ultraviolet light pulse, wherein the first ultraviolet light pulse has the first energy value and the second ultraviolet light pulse has the second energy value. The control system may produce adjacent gratings with different reflectivity amplitudes by alternating between the first and second energy values. The control system may coordinate the alternating energy values with the positioning system to ensure each grating is written at the appropriate location along the optical fiber.

In certain embodiments, the grating writing system may be configured to cause the first ultraviolet light pulse to have a non-uniform spatial energy profile to produce a grating having a non-uniform reflectivity profile. The non-uniform spatial energy profile may have at least one characteristic selected from the group consisting of: strict monotonicity; linearity; similarity to a truncated portion of a Gaussian-like profile; having a ramped shape; variation by less than 30% across the profile; and a minimum energy 70% in a range where no energy is 0% and a highest energy in the profile is 100%.

In certain embodiments, the grating writing system may be configured to cause the first ultraviolet light pulse to have a sloped spatial energy profile, such that the first ultraviolet light pulse writes a grating having a sloped spatial refractive index power profile. The grating writing system may further comprise an aperture component configured to modify a beam profile of the ultraviolet light pulses emitted by the laser source, wherein the aperture component is offset relative to a peak of the beam profile.

In certain embodiments, the grating writing system may further comprise a neutral density filter positioned in an optical path of the ultraviolet light pulses emitted by the laser source, wherein the neutral density filter has a transmission gradient, and wherein the control system may be further configured to adjust an orientation of the neutral density filter to adjust amplitude values of the ultraviolet light pulses to create a non-uniform beam profile. In certain embodiments, the grating writing system may further comprise an aperture component configured to block a part of a beam profile of the first and second ultraviolet light pulses emitted by the laser source. In certain embodiments, the grating writing system may further comprise a beam expander configured to expand a beam profile of ultraviolet light emitted by the laser source and a first aperture component configured to block a part of the expanded beam profile. In certain embodiments, the grating writing system may further comprise a second aperture component located to transmit a sub-region of a beam profile of the ultraviolet light pulses, the sub-region having a uniformity value that is higher than a uniformity value of the beam profile.

In certain embodiments, the positioning system may comprise a linear stage configured to be coupled to a first end portion of the optical fiber and a reel on which a second end portion of the optical fiber is to be wrapped. The control system may be further configured to coordinate motion of the linear stage and the reel via motors to adjust the position of the optical fiber. The motors may be stepper motors, and the control system may coordinate the linear stage and reel motions in a feedback loop with control inputs provided by encoders, accumulators, interrogator measurements, imaging sensors, or other sensors and data.

In certain embodiments, the grating writing system may further comprise at least one component selected from the group consisting of: a position encoder, an accumulator, an interrogator, and an imaging sensor. The at least one component may be configured to provide data for the control system to temporally coordinate firing of the laser source or to adjust an output power of the laser source. For example, the position encoder may be placed to sense a position of a linear actuator that moves the fiber or to sense the position or rotation of a reel that uptakes or rolls out the fiber, and may provide a signal to fire the laser source at the appropriate times and to alternate the laser energies at the appropriate times.

In certain embodiments, the control system may be further configured to cause the positioning system to adjust the position of the optical fiber or the optical component based on a spacing parameter to yield the overlap region between the first portion and the second portion of the optical fiber. The spacing parameter may be less than or equal to a width of a beam profile of the ultraviolet light pulses.

In certain embodiments, the grating writing system may further comprise a feedback component configured to provide a signal indicative of a reflectivity of a grating currently being written or previously written. The control system may be further configured to cause the positioning system to adjust the pose parameter or to change an output energy of the laser source based on the signal. The feedback component may monitor grating reflectivity during the writing process, and the control system may dynamically adjust the pose parameter or change the output energy of the laser source to ensure each grating achieves its target reflectivity amplitude.

### ASPECTS

Aspect 1. A grating writing system for writing gratings in an optical fiber, comprising: a laser source configured to emit ultraviolet light; a positioning system configured to adjust at least one pose parameter selected from the group consisting of: a position the optical fiber, an orientation of the optical fiber, a position of a part of the laser source, an orientation of the part of the laser source, a position of an optical component associated with the laser source, or an orientation of the optical component; and a control system comprising one or more processors, the one or more processors comprising circuitry, the control system configured to control the laser source and to cause the positioning system to adjust the at least one pose parameter such that (i) a first ultraviolet light pulse emitted by the laser source is directed to interact with a first portion of the optical fiber to alter a reflectivity of the first portion by a first amplitude and (ii) a second ultraviolet light pulse emitted by the laser source is directed to interact with a second portion of the optical fiber to alter a reflectivity of the second portion by a second amplitude, wherein the first portion partially overlaps with the second portion in an overlap region, and wherein a ratio of the first amplitude in the overlap region and the second amplitude in the overlap region is nonzero.
Aspect 2. The grating writing system of aspect 1, wherein the reflectivity is measured as a reflective index, and wherein the ratio is not 1.0.
Aspect 3. The grating writing system of aspect 1 or 2, wherein the ratio is between 0.4 and 0.6.
Aspect 4. The grating writing system of aspect 3, wherein the ratio is 0.5.
Aspect 5. The grating writing system of any of aspects 1 through 4, wherein the control system is configured to cause the laser source to emit the first ultraviolet light pulse and the second ultraviolet light pulse during a single writing pass along the optical fiber.
Aspect 6. The grating writing system of any of aspects 1 through 5, wherein control system is configured to: cause the laser source to emit the first ultraviolet light pulse during a first writing pass along the optical fiber; and cause the laser source to emit the second ultraviolet light pulse during a second writing pass along the optical fiber, the second writing pass occurring before an initiation of the first writing pass or after a completion of the first writing pass.
Aspect 7. The grating writing system of any of aspects 1 to 6, wherein the control system is configured to provide the first ultraviolet light pulse at a first energy value and the second ultraviolet light pulse at a second energy value that is different from the first energy value.
Aspect 8. The grating writing system of aspect 7, wherein to provide the first ultraviolet light pulse at the first energy value and the second ultraviolet light pulse at the second energy value, the control system is configured to control an output energy of the laser source.
Aspect 9. The grating writing system of aspect 7 or 8, wherein to provide the first ultraviolet light pulse at the first energy value and the second ultraviolet light pulse at the second energy value, the control system is configured to: temporally coordinate the laser source providing ultraviolet light with activation or actuation of an energy changing component of the grating writing system.
Aspect 10. The grating writing system of aspect 9, wherein: the energy changing component comprises a light attenuating component, a light blocking component, a light spreading component, or a light augmenting component; or to temporally coordinate the laser source providing ultraviolet light with the activation or actuation of the energy changing component, the control system is configured to synchronously trigger the laser source and a change in the activation or actuation of the energy changing component.
Aspect 11. The grating writing system of any of aspects 7 through 10, further comprising: an attenuator; and wherein to provide the first ultraviolet light pulse at the first energy value and the second ultraviolet light pulse at the second energy value, the control system is configured to temporally coordinate the laser source emitting the first and second ultraviolet light pulses with an attenuation of the attenuator.
Aspect 12. The grating writing system of any of aspects 7 through 11, further comprising: a filter wheel; and wherein to provide the first ultraviolet light pulse at the first energy value and the second ultraviolet light pulse at the second energy value, the control system is configured to temporally coordinate the laser source providing ultraviolet light with a rotation of the filter wheel to selectively position one or more filters of the filter wheel in an optical path of the ultraviolet light.
Aspect 13. The grating writing system of any of aspects 7 through 12, further comprising: a filter mounting mechanism configured to attach one or more filters to a damped resonant structure; and wherein to provide the first ultraviolet light pulse at the first energy value and the second ultraviolet light pulse at the second energy value, the control system is configured to temporally coordinate the laser source providing ultraviolet light with a with a position adjustment to the damped resonant structure to selectively position the one or more filters in an optical path of the ultraviolet light.
Aspect 14. The grating writing system of any of aspects 1 through 13, wherein the control system is configured to cause the laser source to provide a sequence of ultraviolet light pulses alternating between first and second energy values, wherein the sequence of ultraviolet light pulses comprises the first ultraviolet light pulse and the second ultraviolet light pulse, wherein the first ultraviolet light pulse has the first energy value, and wherein the second ultraviolet light pulse has the second energy value.
Aspect 15. The grating writing system of any of aspects 1 through 14, wherein the grating writing system is configured to: cause the first ultraviolet light pulse to have a non-uniform spatial energy profile to produce a grating having a non-uniform reflectivity profile.
Aspect 16. The grating writing system of aspect 15, wherein the non-uniform spatial energy profile has at least one characteristic selected from the group consisting of: strict monotonicity; linearity; similarity to a truncated portion of a Gaussian-like profile; having a ramped shape; variation by less than 30% across the profile; and a minimum energy 70% in a range where no energy is 0% and a highest energy in the profile is 100%.
Aspect 17. The grating writing system of any of aspects 1 through 16, wherein the grating writing system is configured to: cause the first ultraviolet light pulse to have a sloped spatial energy profile, such that the first ultraviolet light pulse writes a grating having a sloped spatial refractive index power profile.
Aspect 18. The grating writing system of aspect 17, further comprising: an aperture component configured to modify a beam profile of the ultraviolet light pulses emitted by the laser source; wherein the aperture component is offset relative to a peak of the beam profile.
Aspect 19. The grating writing system of any of aspects 1 through 18, further comprising: a neutral density filter positioned in an optical path of the ultraviolet light pulses emitted by the laser source, wherein the neutral density filter has a transmission gradient; and the control system is further configured to adjust an orientation of the neutral density filter to adjust amplitude values of the ultraviolet light pulses to create a non-uniform beam profile.
Aspect 20. The grating writing system of any of aspects 1 through 19, further comprising: an aperture component configured to block a part of a beam profile of the first and second ultraviolet light pulse emitted by the laser source.
Aspect 21. The grating writing system of any of aspects 1 through 20, further comprising: a beam expander configured to expand a beam profile of ultraviolet light emitted by the laser source; and an aperture component configured to block a part of the expanded beam profile.
Aspect 22. The grating writing system of any of aspects 1 through 21 , wherein: the positioning system comprises a linear stage configured to be coupled to a first end portion of the optical fiber and a reel on which a second end portion of the optical fiber is to be wrapped; and the control system is further configured to coordinate motion of the linear stage and the reel via motors to adjust the position of the optical fiber.
Aspect 23. The grating writing system of any of aspects 1 through 22, further comprising at least one component selected from the group consisting of: (i) a position encoder, (ii) an accumulator, (iii) an interrogator, and (iv) an imaging sensor, wherein the at least one component is configured to provide data for the control system to temporally coordinate firing of the laser source or to adjust an output power of the laser source.
Aspect 24. The grating writing system of any of aspects 1 through 23, wherein the control system is further configured to: cause the positioning system to adjust the position of the optical fiber or the optical component based on a spacing parameter to yield the overlap region between the first portion and the second portion of the optical fiber, wherein the spacing parameter is less than or equal to a width of a beam profile of the ultraviolet light pulses.
Aspect 25. The grating writing system of any of aspects 1 through 24, further comprising: a feedback component configured to provide a signal indicative of a reflectivity of a grating currently being written or previously written, wherein the control system is further configured to cause the positioning system to adjust the pose parameter or to change an output energy of the laser source based on the signal.
Aspect 26. The grating writing system of any of aspects 1 through 25, further comprising: an aperture component located to transmit a sub-region of a beam profile of the ultraviolet light pulses, the sub-region having a uniformity value that is higher than a uniformity value of the beam profile.
Aspect 27. An optical fiber sensor, comprising: a strand of glass or plastic; a first grating disposed in a first portion of the strand, the first grating altering a reflectivity of the first portion by a first amplitude compared to a reflectivity of the strand without any gratings; and a second grating disposed in a second portion of the strand, the second grating altering a reflectivity of the second portion by a second amplitude compared to a reflectivity of the strand without any gratings, wherein the first portion and the second portion partially overlap in an overlap region, and wherein a ratio of the first amplitude and the second amplitude in the overlap region is nonzero.
Aspect 28. An optical fiber sensor comprising: an optical core; a first grating in the optical core having a first spatial reflectivity profile; and a second grating in the optical core having a second spatial reflectivity profile, the first grating and the second grating overlapping in an overlap region, wherein a first value of the first spatial reflectivity profile in the overlap region differs from a second value of the second spatial reflectivity profile in the overlap region, and wherein the first and second values are nonzero.
Aspect 29. The optical fiber sensor of aspect 28, wherein the optical fiber sensor comprises: a fiber containing a plurality of cores; or a plurality of single-core fibers fixed to each other; or a fiber containing a plurality of cores fixed to at least one single-core fiber.
Aspect 30. The optical fiber sensor of aspect 28 or 29, wherein a ratio of the first and second values is: higher than 0.2; or lower than 0.8.
Aspect 31. The optical fiber sensor of any of aspects 28 through 30, wherein a ratio of the first and second values is between 0.4 and 0.6.
Aspect 32. The optical fiber sensor of any of aspects 28 through 31, wherein a ratio of the first and second values is 0.5.
Aspect 33. The optical fiber sensor of any of aspects 28 through 32, wherein the first grating is created by a first ultraviolet light pulse having a first energy value and the second grating is created by a second ultraviolet light pulse having a second energy value that is different from the first energy value.
Aspect 34. The optical fiber sensor of any of aspects 28 through 33, wherein the first grating has a first non-uniform reflectivity profile, and wherein the second grating has a second non-uniform reflectivity profile.
Aspect 35. The optical fiber sensor of any of aspects 28 through 34, wherein the first grating has a first non-uniform reflectivity profile, and wherein the second grating has a second non-uniform reflectivity profile.
Aspect 36. The optical fiber sensor of aspect 35 wherein the first non-uniform reflectivity profile has at least one characteristic selected from the group consisting of: strict monotonicity; linearity; similarity to a truncated portion of a Gaussian-like profile; having a ramped shape; variation by less than 30% across the profile; and a minimum reflectivity of at least 70% in a range where a region with no gratings is 0% and a highest region of reflectivity in the grating is 100%.
Aspect 37. A method for writing overlapping gratings in an optical fiber, comprising the steps of: causing, by a control system comprising one or more processors, an adjustment to at least one pose parameter selected from the group consisting of: a position of the optical fiber, an orientation of the optical fiber, a position of a part of a laser source configured to emit ultraviolet light, an orientation of the part of the laser source, a position of an optical component associated with the laser source, or an orientation of the optical component; and causing, by the control system, the laser source to emit (i) a first ultraviolet light pulse that is directed to interact with a first portion of the optical fiber to alter a reflectivity of the first portion by a first amplitude and (ii) a second ultraviolet light pulse directed to interact with a second portion of the optical fiber to alter a reflectivity of the second portion by a second amplitude, wherein the first portion partially overlaps with the second portion in an overlap region, and wherein a ratio of the first amplitude in the overlap region and the second amplitude in the overlap region is nonzero.

One or more components of the embodiments discussed in this disclosure, such as control system 142, may be implemented in software for execution on one or more processors of a computer system. The software may include code that when executed by the one or more processors, configures the one or more processors to perform various functionalities as discussed herein. The code may be stored in a non-transitory computer readable storage medium (e.g., a memory, magnetic storage, optical storage, solid-state storage, etc.). The computer readable storage medium may be part of a computer readable storage device, such as an electronic circuit, a semiconductor device, a semiconductor memory device, a read only memory (ROM), a flash memory, an erasable programmable read only memory (EPROM); a floppy diskette, a CD-ROM, an optical disk, a hard disk, or other storage device. The code may be downloaded via computer networks such as the Internet, Intranet, etc. for storage on the computer readable storage medium. The code may be executed by any of a wide variety of centralized or distributed data processing architectures. The programmed instructions of the code may be implemented as a number of separate programs or subroutines, or they may be integrated into a number of other aspects of the systems described herein. The components of the computing systems discussed herein may be connected using wired and/or wireless connections. In some examples, the wireless connections may use wireless communication protocols such as Bluetooth, near-field communication (NFC), Infrared Data Association (IrDA), home radio frequency (HomeRF), IEEE 802.11, Digital Enhanced Cordless Telecommunications (DECT), and wireless medical telemetry service (WMTS).

Various general-purpose computer systems may be used to perform one or more processes, methods, or functionalities described herein. Additionally or alternatively, various specialized computer systems may be used to perform one or more processes, methods, or functionalities described herein. In addition, a variety of programming languages may be used to implement one or more of the processes, methods, or functionalities described herein.

While certain embodiments and examples have been described above and shown in the accompanying drawings, it is to be understood that such embodiments and examples are merely illustrative and are not limited to the specific constructions and arrangements shown and described, since various other alternatives, modifications, and equivalents will be appreciated by those with ordinary skill in the art.

What is claimed:

1. An optical fiber sensor comprising:
an optical core;
a first grating in the optical core having a first spatial reflectivity profile; and
a second grating in the optical core having a second spatial reflectivity profile, the first grating and the second grating overlapping in an overlap region, wherein a ratio of a first value of the first spatial reflectivity profile in the overlap region to a second value of the second spatial reflectivity profile in the overlap region is nonzero and differs from 1.0.

2. The optical fiber sensor of claim 1, wherein the optical fiber sensor comprises:
a fiber containing a plurality of cores;
a plurality of single-core fibers fixed to each other; or
a fiber containing a plurality of cores fixed to at least one single-core fiber.

3. The optical fiber sensor of claim 1, wherein the ratio of the first and second values is:
higher than 0.2; or
lower than 0.8.

4. The optical fiber sensor of claim 1, wherein the ratio of the first and second values is between 0.4 and 0.6.

5. The optical fiber sensor of claim 1, wherein the ratio of the first and second values is 0.5.

6. The optical fiber sensor of claim 1, wherein the first grating is created by a first ultraviolet light pulse having a first energy value and the second grating is created by a second ultraviolet light pulse having a second energy value that is different from the first energy value.

7. The optical fiber sensor of claim 1, wherein the first grating has a first non-uniform reflectivity profile, and wherein the second grating has a second non-uniform reflectivity profile.

8. The optical fiber sensor of claim 7, wherein the first non-uniform reflectivity profile has at least one characteristic selected from the group consisting of:
strict monotonicity;
linearity;
similarity to a truncated portion of a Gaussian-like profile;
having a ramped shape;
variation by less than 30% across the profile; and
a minimum reflectivity of at least 70% in a range where a region with no gratings is 0% and a highest region of reflectivity in the grating is 100%.

9. A grating writing system for writing gratings in an optical fiber, comprising:
a laser source configured to emit ultraviolet light;
a positioning system configured to adjust at least one pose parameter selected from the group consisting of: a position the optical fiber, an orientation of the optical fiber, a position of a part of the laser source, an orientation of the part of the laser source, a position of an optical component associated with the laser source, or an orientation of the optical component; and
a control system comprising one or more processors, the one or more processors comprising circuitry, the control system configured to control the laser source and to cause the positioning system to adjust the at least one pose parameter such that (i) a first ultraviolet light pulse emitted by the laser source is directed to interact with a first portion of the optical fiber to alter a reflectivity of the first portion by a first amplitude and (ii) a second ultraviolet light pulse emitted by the laser source is directed to interact with a second portion of the optical fiber to alter a reflectivity of the second portion by a second amplitude, wherein the first portion partially overlaps with the second portion in an overlap region, and wherein a ratio of the first amplitude in the overlap region and the second amplitude in the overlap region is nonzero and differs from 1.0.

10. The grating writing system of claim 9, wherein the control system is configured to at least one of:
cause the laser source to emit the first ultraviolet light pulse and the second ultraviolet light pulse during a single writing pass along the optical fiber; or
cause the laser source to:
emit the first ultraviolet light pulse during a first writing pass along the optical fiber; and
emit the second ultraviolet light pulse during a second writing pass along the optical fiber, the second writing pass occurring before an initiation of the first writing pass or after a completion of the first writing pass.

11. The grating writing system of claim 9, wherein the control system is configured to provide the first ultraviolet light pulse at a first energy value and the second ultraviolet light pulse at a second energy value that is different from the first energy value, and wherein to provide the first ultraviolet light pulse at the first energy value and the second ultraviolet light pulse at the second energy value, the control system is configured to at least one of:
control an output energy of the laser source; or
temporally coordinate the laser source providing ultraviolet light with activation or actuation of an energy changing component of the grating writing system; and
wherein:
the energy changing component comprises a light attenuating component, a light blocking component, a light spreading component, or a light augmenting component; or
to temporally coordinate the laser source providing ultraviolet light with the activation or actuation of the energy changing component, the control system is configured to synchronously trigger the laser source and a change in the activation or actuation of the energy changing component.

12. The grating writing system of claim 9, further comprising at least one of:
an attenuator, and wherein to provide the first ultraviolet light pulse at a first energy value and the second ultraviolet light pulse at a second energy value, the control system is configured to temporally coordinate the laser source emitting the first and second ultraviolet light pulses with an attenuation of the attenuator;
a filter wheel, and wherein to provide the first ultraviolet light pulse at the first energy value and the second ultraviolet light pulse at the second energy value, the control system is configured to temporally coordinate the laser source providing ultraviolet light with a rotation of the filter wheel to selectively position one or more filters of the filter wheel in an optical path of the ultraviolet light; or
a filter mounting mechanism configured to attach one or more filters to a damped resonant structure, and wherein to provide the first ultraviolet light pulse at the first energy value and the second ultraviolet light pulse at the second energy value, the control system is configured to temporally coordinate the laser source providing ultraviolet light with a with a position adjustment to the damped resonant structure to selectively position the one or more filters in an optical path of the ultraviolet light.

13. The grating writing system of claim 9, wherein the control system is configured to cause the laser source to provide a sequence of ultraviolet light pulses alternating between first and second energy values, wherein the sequence of ultraviolet light pulses comprises the first ultraviolet light pulse and the second ultraviolet light pulse, wherein the first ultraviolet light pulse has the first energy value, and wherein the second ultraviolet light pulse has the second energy value.

14. The grating writing system of claim 9, wherein the grating writing system is configured to:
cause the first ultraviolet light pulse to have a sloped spatial energy profile, such that the first ultraviolet light pulse writes a grating having a sloped spatial refractive index power profile; and
the grating writing system further comprises:
an aperture component configured to modify a beam profile of the ultraviolet light pulses emitted by the laser source;
wherein the aperture component is offset relative to a peak of the beam profile.

15. The grating writing system of claim 9, further comprising at least one of:
(a) a neutral density filter positioned in an optical path of the ultraviolet light pulses emitted by the laser source, wherein the neutral density filter has a transmission gradient, and wherein the control system is further configured to adjust an orientation of the neutral density filter to adjust amplitude values of the ultraviolet light pulses to create a non-uniform beam profile;
(b) an aperture component configured to block a part of a beam profile of the first and second ultraviolet light pulse emitted by the laser source;
(c) a beam expander configured to expand a beam profile of ultraviolet light emitted by the laser source and a first aperture component configured to block a part of the expanded beam profile;
(d) a second aperture component located to transmit a sub-region of a beam profile of the ultraviolet light pulses, the sub-region having a uniformity value that is higher than a uniformity value of the beam profile; or
(e) a feedback component configured to provide a signal indicative of a reflectivity of a grating currently being written or previously written, wherein the control system is further configured to cause the positioning system to adjust the pose parameter or to change an output energy of the laser source based on the signal.

16. The grating writing system of claim 9, wherein:
the positioning system comprises a linear stage configured to be coupled to a first end portion of the optical fiber and a reel on which a second end portion of the optical fiber is to be wrapped; and
the control system is further configured to coordinate motion of the linear stage and the reel via motors to adjust the position of the optical fiber.

17. The grating writing system of claim 9, further comprising at least one component selected from the group consisting of: (i) a position encoder, (ii) an accumulator, (iii) an interrogator, and (iv) an imaging sensor, wherein the at least one component is configured to provide data for the control system to temporally coordinate firing of the laser source or to adjust an output power of the laser source.

18. The grating writing system of claim 9, wherein the control system is further configured to:
cause the positioning system to adjust the position of the optical fiber or the optical component based on a spacing parameter to yield the overlap region between the first portion and the second portion of the optical fiber, wherein the spacing parameter is less than or equal to a width of a beam profile of the ultraviolet light pulses.

19. A method for writing overlapping gratings in an optical fiber, the method comprising:
causing, by a control system comprising one or more processors, an adjustment to at least one pose parameter selected from the group consisting of: a position of the optical fiber, an orientation of the optical fiber, a position of a part of a laser source configured to emit ultraviolet light, an orientation of the part of the laser source, a position of an optical component associated with the laser source, or an orientation of the optical component; and
causing, by the control system, the laser source to emit (i) a first ultraviolet light pulse that is directed to interact with a first portion of the optical fiber to alter a reflectivity of the first portion by a first amplitude and (ii) a second ultraviolet light pulse directed to interact with a second portion of the optical fiber to alter a reflectivity of the second portion by a second amplitude, wherein the first portion partially overlaps with the second portion in an overlap region, and wherein a ratio of the first amplitude in the overlap region and the second amplitude in the overlap region is nonzero and differs from 1.0.

20. The method of claim 19, further comprising:
causing, by the control system, a positioning system to adjust the position of the optical fiber or the optical component based on a spacing parameter to yield the overlap region between the first portion and the second portion of the optical fiber, wherein the spacing parameter is less than or equal to a width of a beam profile of the ultraviolet light pulses.
